(19) United States
(12) Patent Application Publication
(10) Pub. No.: US 2001/0033265 A1
(43) Pub. Date: Oct. 25, 2001

(54) Liquid crystal display device

(76) Inventors: Yasuyuki Mishima, Mobara (JP); Shunsuke Morishita, Mobara (JP); Nobuyuki Suzuki, Mobara (JP); Takanori Nakayama, Mobara (JP); Hikaru Ito, Mobara (JP)

Correspondence Address: Robert C. Colwell, TOWNSEND and TOWNSEND and CREW LLP, Two Embarcadero Center, 8th Floor, San Francisco, CA, 94111-3834, US

(21) Appl. No.: 09/783,070

(22) Filed: Feb. 13, 2001

(30) Foreign Application Priority Data
Mar. 1, 2000 (JP) 2000-055563

(51) Int. Cl. G09G 3/36

(52) U.S. Cl. 345/92

(57) ABSTRACT

A liquid crystal display device which is free of luminance irregularity includes, in each of pixels on a liquid-crystal-side surface of a substrate disposed in opposition to a liquid crystal, a thin film transistor to be driven by supply of a scanning signal from a gate signal line, a pixel electrode to be supplied with a video signal from a drain line via the thin film transistor, and a counter electrode which generates an electric field having a component parallel to the pixel electrode and the substrate. In the liquid crystal display device, a UXGA display area is constituted by an assembly of the pixels, and the scanning signal has a delay time set to 3.8 μs or less at the pixel in the display area that is located on a terminal side of the gate signal line which is opposite to an input side thereof.

### CROSS-REFERENCES TO RELATED APPLICATIONS

This application claims priority from, and incorporates by reference the entire disclosures of, Japanese Patent Application No. JP2000-055563, filed on Mar. 1, 2000.

### BACKGROUND OF THE INVENTION

The present invention relates to a liquid crystal display device and, more particularly, to a high-resolution liquid crystal display device.

A liquid crystal display device has a vessel made of substrates disposed to oppose each other with a liquid crystal interposed therebetween, and is provided with a display area made of multiple pixels in the direction of expansion of the liquid crystal.

With the recent improvement in technology, high-resolution liquid crystal display devices which conform to a so-called UXGA standard have been becoming popular.

Specifically, such a liquid crystal display device has 1600×1200 pixels each made of adjacent pixels for R, G and B, and there is a tendency for its panel itself to increase in size.

However, as the panel becomes larger in size, signal lines which supply signals to the individual pixels become longer and the waveform distortions of the signals due to the resistances and capacitances of the signal lines become larger, so that it becomes difficult to avoid occurrence of luminance irregularity.

When the status of use of liquid crystal display devices is taken into consideration, their panels need not necessarily be large in size, and it is also possible to take into account the case in which if the panels have adequate sizes, there are no particular inconveniences.

### SUMMARY OF THE INVENTION

The present invention has been made on the basis of such circumstances, and provides a liquid crystal display device free of luminance irregularity.

The present invention also provides a liquid crystal display device which can be reduced in the area of each pixel and can be formed into an appropriate size as the whole.

Representative aspects of the invention disclosed in the present application will be described below. A liquid crystal display device comprising a pair of substrates, a liquid crystal layer interposed between the pair of substrates, a thin film transistor formed on one of the pair of substrates and to be driven by supply of a scanning signal from a gate line, a pixel electrode formed on one of the pair of substrates and to be supplied with a video signal from a drain line via the thin film transistor, a counter electrode formed on one of the pair of substrates and to be supplied with a counter voltage signal from a counter voltage signal line, pixels being constructed with a plurality of the gate line and a plurality of the drain line arranged in a matrix on one of the pair of substrates, a UXGA display area being constituted by an assembly of the pixels, wherein the scanning signal having a delay time set to 3.8 μs or less at a terminal side of the gate line being to opposite to an input side thereof.

According to the liquid crystal display device constructed in this manner, although a high-resolution picture can be obtained, it is possible to prevent the scanning signal supplied to the gate signal line from producing waveform distortion which gives inconveniences to visual display even at a location away from an input side of the gate signal line.

Moreover it is possible to reduce the size of each pixel, and a liquid crystal display panel which conforms to a UXGA standard can be constructed as a panel of appropriate size because the size of the panel does not excessively increase.

### BRIEF DESCRIPTION OF THE DRAWINGS

The invention will become more readily appreciated and understood from the following detailed description of preferred embodiments of the invention when taken in conjunction with the accompanying drawings, in which:

FIG. 1 is an exploded perspective view (viewed from a liquid-crystal-display-panel side) of a liquid crystal display device according to the present invention;

FIG. 2 is an exploded perspective view (viewed from the reverse side of the liquid crystal display device, i.e., from the opposite side to FIG. 1) of the liquid crystal display device according to the present invention;

FIGS. 3A to 3G are assembly diagrams, viewed from the right side (III direction) of FIG. 1, of the liquid crystal display device according to the present invention;

FIG. 3H is a skeleton view, viewed from the right side (III direction) of FIG. 1, of the liquid crystal display device according to the present invention;

FIG. 3I is a view showing an external appearance of the liquid crystal display device according to the present invention;

FIG. 4 is a perspective view, viewed from the left side (IV direction) of FIG. 1, of the liquid crystal display device according to the present invention;

FIGS. 5A to 5C are assembly diagrams, viewed from the front side (V direction) of FIG. 1, of the liquid crystal display device according to the present invention;

FIG. 5D is a skeleton view, viewed from the front side (V direction) of FIG. 1, of the liquid crystal display device according to the present invention;

FIG. 6 is a view of the liquid crystal display device according to the present invention, viewed from the top side of FIG. 2 (i.e., the reverse side of the liquid crystal display device);

FIG. 7A is an explanatory view of a first construction according to the present invention, showing the case in which a light source driver circuit is provided in the liquid crystal display device;

FIG. 7B is an explanatory view of the first construction according to the present invention, showing the case in which a light source driver circuit is not provided in the liquid crystal display device;

FIG. 8 is an explanatory view showing the state in which liquid crystal display devices are packaged for shipping;

FIG. 9A is an explanatory view of a second construction according to the present invention, showing the state in which a light source unit is removed from the liquid crystal display device;

FIG. 9B is an enlarged view of the structure shown within a circle of FIG. 9A;

FIG. 10A is a side view showing one example of a monitor using a liquid crystal display device according to the present invention;

FIG. 10B is a front view (a view seen from a monitor side, i.e., a user side of the monitor);

FIG. 10C is a side view showing the state in which a light source unit is removed from the monitor;

FIG. 11 is a circuit diagram showing a display matrix part and peripheral circuits of the liquid crystal display device;

FIG. 12 is a plan view showing one embodiment of a pixel of the liquid crystal display device;

FIG. 13 is a cross-sectional view taken along line XIII-XIII of FIG. 12;

FIG. 14 is an explanatory view showing so-called one-side feeding of scanning signals and video signals;

FIGS. 15A and 15B are explanatory views showing the waveform distortions of a scanning signal, a video signal and a counter signal;

FIG. 16 is an explanatory view showing so-called both-side feeding of scanning signals and video signals;

FIG. 17 is a graph which enables the delay time of a scanning signal on a gate signal line to be considered from the relationship between the resistance and the capacitance of the gate signal line;

FIG. 18 is a graph which enables the delay time of a video signal on a drain line to be considered from the relationship between the resistance and the capacitance of the drain line;

FIG. 19 is a graph which enables the delay time of a counter signal on a counter signal line to be considered from the relationship between the resistance and the capacitance of the counter signal line;

FIG. 20 is a graph obtained by finding luminance relative to the drive voltage of the liquid crystal display device from the relationship between the luminance and the dielectric anisotropy of a liquid crystal;

FIG. 21 is a graph obtained by finding drive voltage relative to the space between electrodes of the liquid crystal display device from the relationship between the drive voltage and the dielectric anisotropy of a liquid crystal; and

FIG. 22 is a graph showing the relationship between the diagonal display size and the lateral size of a liquid crystal display device.

### DESCRIPTION OF THE SPECIFIC EMBODIMENTS

Preferred embodiments of the present invention will be described below in detail with reference to the accompanying drawings. Incidentally, throughout the drawings which will be referred to in the following description, members or portions having the same functions are denoted by the same reference numerals or signs, respectively, and the repetitive descriptions of such members or portions are omitted herein.

### <<Entire Construction of Liquid Crystal Display Device>>

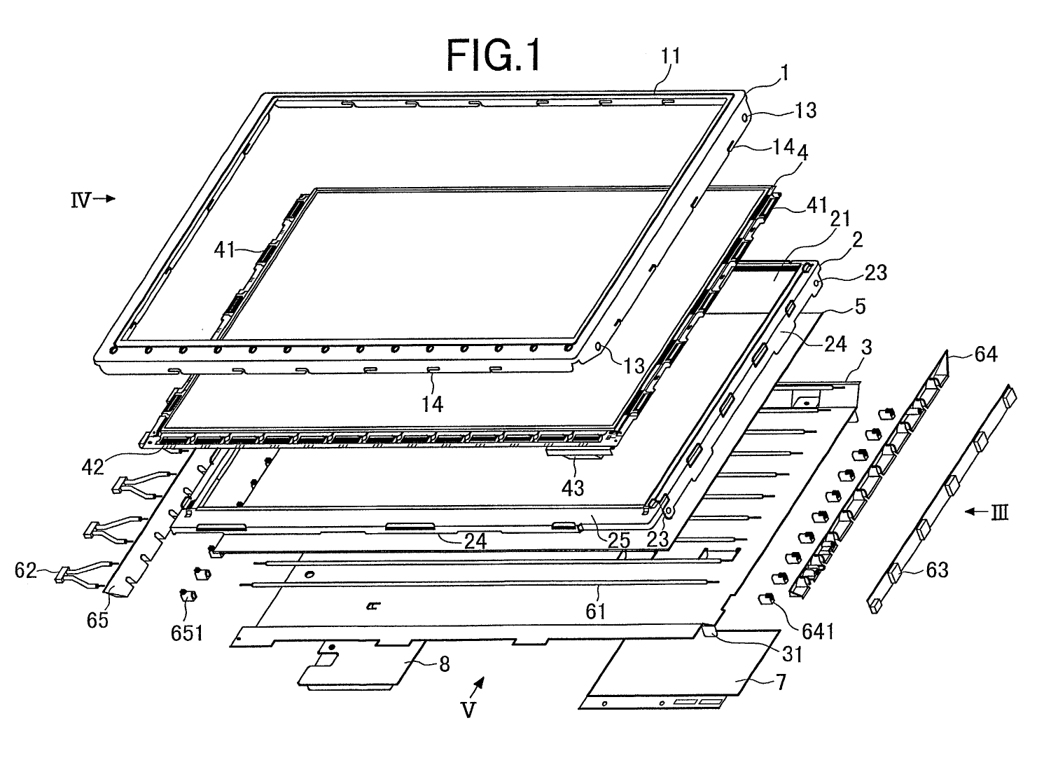

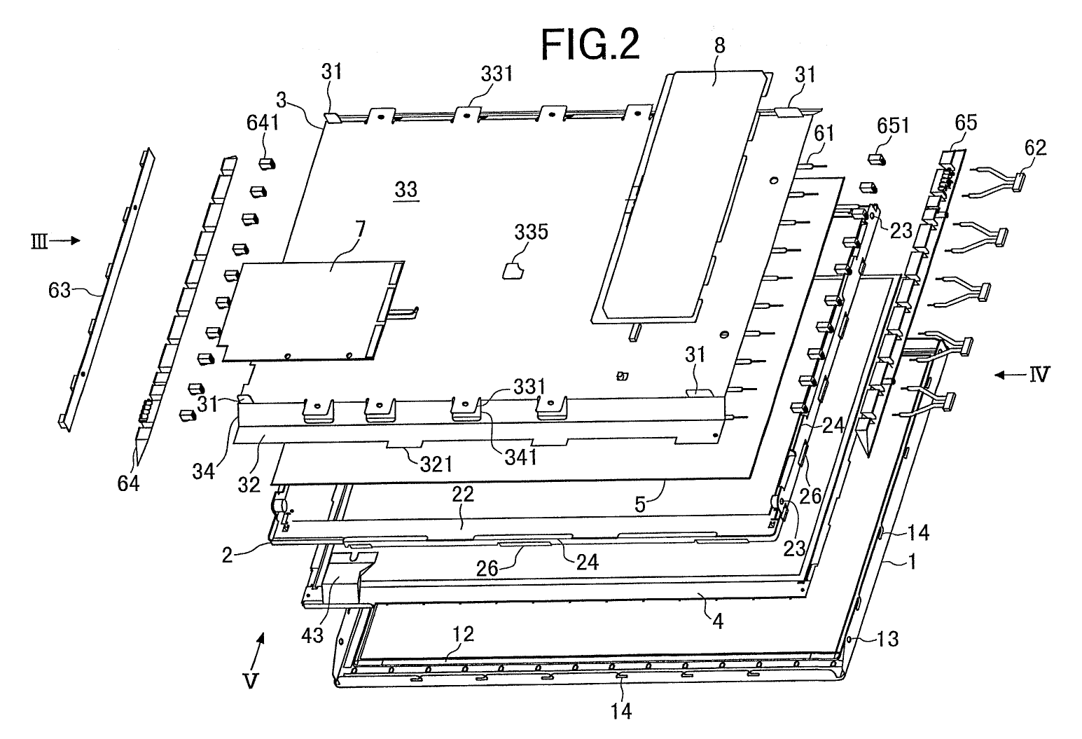

FIGS. 1 and 2 are exploded perspective views showing a liquid crystal display device according to the present invention.

FIG. 1 shows the liquid crystal display device in the form of an exploded perspective view taken on a side where a liquid crystal display panel is disposed (the obverse side of the liquid crystal display device with respect to the field of view of a user), and FIG. 2 shows the liquid crystal display device in the form of an exploded perspective view taken on the opposite side (the reverse side of the liquid crystal display device with respect to the field of view of the user).

In FIG. 1, reference numeral 1 denotes a first case, reference numeral 2 a second case, reference numeral 3 a third case, reference numeral 4 an optical sheet (which includes a diffusion film disposed on a light-source side and a prism film disposed on a display-panel side), reference numeral 61 cold-cathode tubes, reference numeral 7 a timing converter circuit board, reference numeral 8 a light source control circuit board which constitutes a light source control circuit, reference numeral 11 an aperture of the first case 1 (a liquid crystal display window), reference numeral 21 an aperture of the second case 2, reference numeral 13 holes of the first case 1, reference numeral 23 holes of the second case 2, reference numeral 14 notches of the first case 1 (the notches are bent to secure the first case 1), reference numeral 24 projections of the second case 2, reference numeral 22 a terrace of the second case 2, reference numerals 64 and 65 frames, reference numerals 641 and 651 rubber bushings, reference numeral 43 a flexible printed circuit board, reference numeral 62 connectors (higher-voltage side), reference numeral 63 a connector (lower-voltage side), reference numeral 41 gate driver ICs, and reference numeral 42 drain driver ICs.

In FIG. 2, reference numeral 31 projections provided on the third case 3 for projecting the component parts of the timing converter circuit board 7, reference numeral 32 a terrace surface, reference numerals 321 and 331 aprons, reference numeral 33 an upper surface, reference numeral 34 a side surface, reference numeral 341 openings at which to form the aprons 331, and reference numeral 335 an opening for monitoring the luminance of a light source.

The liquid crystal display device is assembled by securing the liquid crystal display panel 4 between the first case 1 and the second case 2, and securing to the second case 2 the third case 3 to which a light source unit including the cold-cathode tubes (or discharge tubes) 61 are secured. The second case 2 is removably secured to the third case 3. The first case 1, the second case 2 and the third case 3 are stacked on one another to constitute the liquid crystal display device.

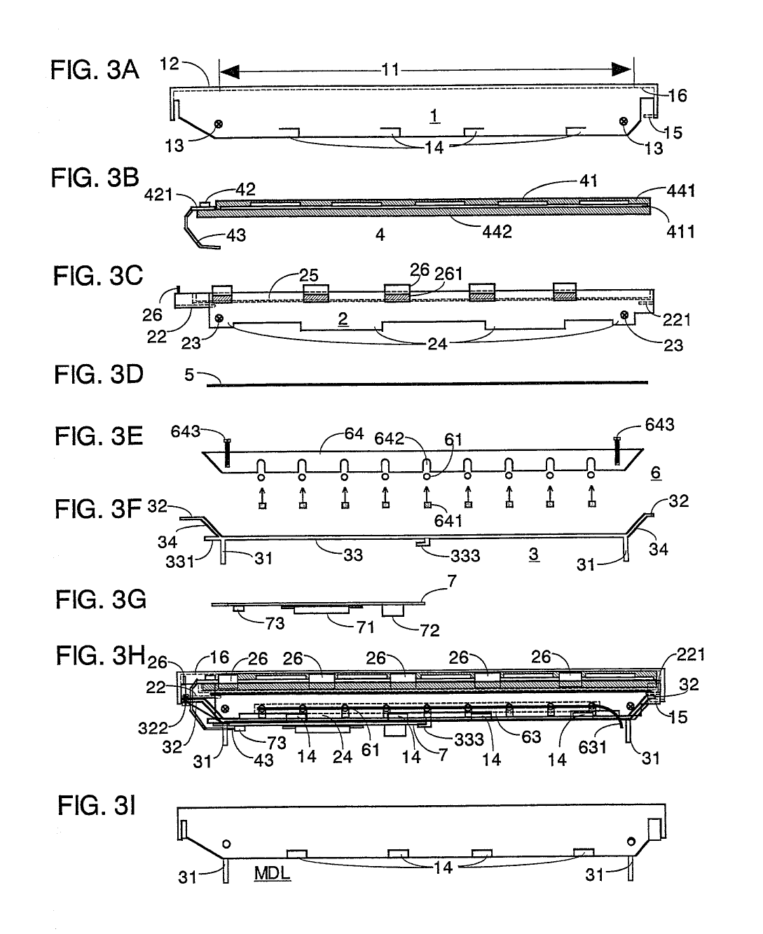

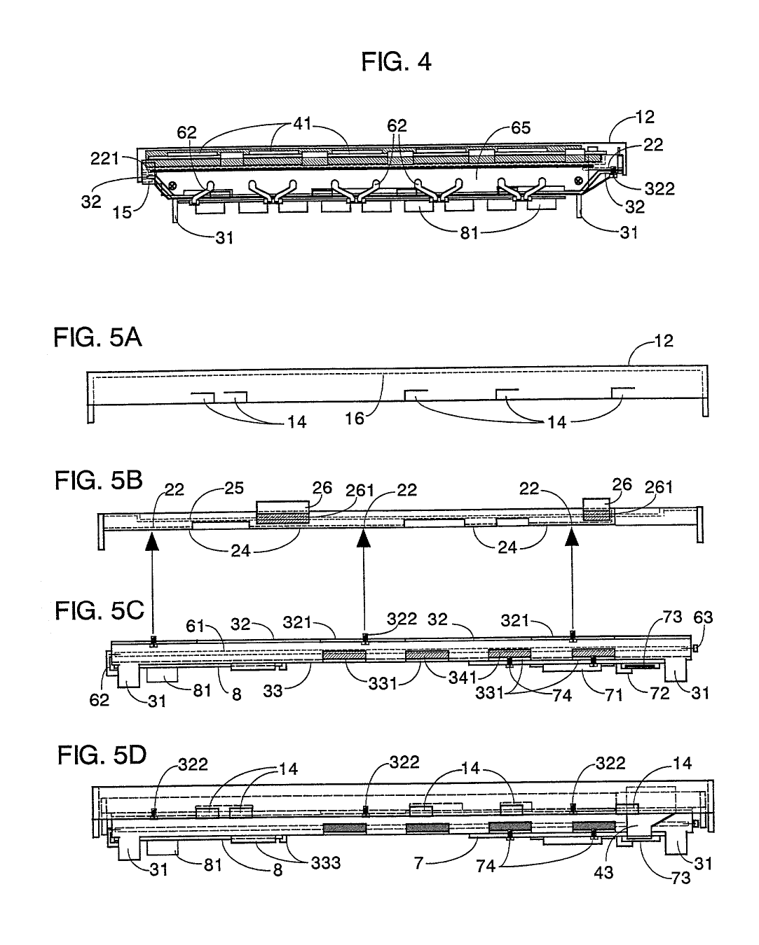

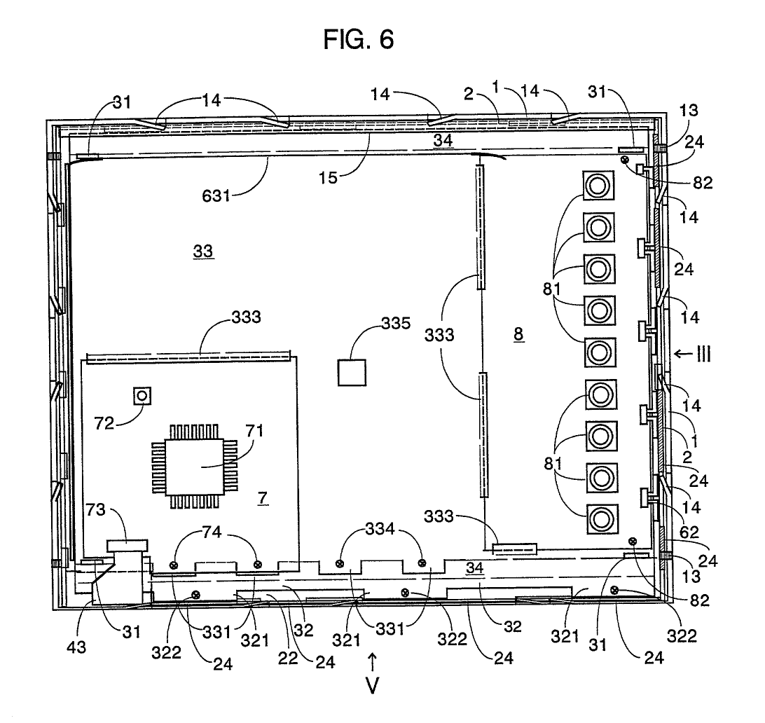

FIGS. 3A to 3I are detailed assembly diagrams and a completion diagram of the liquid crystal display device as viewed in the III direction of FIG. 1. FIG. 4 is a detailed assembly diagram and a perspective view of the liquid crystal display device as viewed in the IV direction of FIG. 1. FIGS. 5A to 5D are conceptual assembly diagrams and a completion diagram of the liquid crystal display device as viewed in the V direction of FIG. 1. FIG. 6 is a completion diagram showing the assembled state of the liquid crystal display device of FIG. 2 in bird's eye view (the reverse side of the liquid crystal display device with respect to the field of view of the user). By way of illustration, the constructions shown in FIGS. 3A to 6 are partly modified from those shown in FIGS. 1 and 2. For example, the number (ten) of the cold-cathode tubes 61 shown in FIGS. 1 and 2 are reduced to nine in FIGS. 3A to 6.

In FIG. 3A, reference numeral 12 denotes an upper surface of the first case 1, reference numeral 15 a terrace of the first case 1, and reference numeral 16 a lower surface of the first case 1.

In FIG. 3B, reference numerals 411 and 421 denote printed circuit boards, and reference numerals 441 and 442 denote LCD substrates.

In FIG. 3C, reference numeral 25 denotes an upper surface (LCD-substrate support portion) of the second case 2, reference numeral 26 projections, reference numeral 261 openings in which the respective projections 26 are disposed, reference numeral 221 a terrace.

In FIG. 3E, reference numeral 642 denotes grooves formed in the frame 64 for holding the cold-cathode tubes 61, and reference numeral 643 denotes screws.

In FIG. 3F, reference numeral 333 denotes a hanger.

In FIG. 3G, reference numeral 71 denotes a timing converter LSI, reference numeral 72 a voltage transformation element (ferrite core), and reference numeral 73 a connector (port).

In FIG. 3H, reference numeral 631 denotes a cable (lower-voltage side).

In FIG. 3I, sign MDL denotes a liquid crystal display module.

In FIG. 4, reference numeral 81 denotes voltage transformation elements (ferrite cores).

In FIGS. 5A to 5D, reference numeral 74 denotes screws which secure the timing converter circuit board 7 to the outside surface of the third case 3, reference numeral 82 denotes screws which secure the light source control circuit board 8 to the outside surface of the third case 3, and reference numeral 334 denotes threaded holes.

### <<Liquid Crystal Display Panel 4>>

As shown in FIG. 3B, the liquid crystal display panel 4 has a body which includes one pair of substrates 441 and 442 and the liquid crystal compounds sealed therebetween, and the driver ICs (integrated circuit elements) 41 and 42 which apply electric fields to the liquid crystal compounds to change the optical transmissivity of light with respect to the direction in which light is transmitted through the substrates. The driver ICs 41 and 42 are respectively arranged on the printed circuit boards 411 and 421, and the printed circuit boards 411 and 421 are mounted on the periphery of the substrate 442 which is one of the pair of substrates 441 and 442. The liquid crystal compounds sealed between the pair of pair of substrates 441 and 442 constitute a so-called liquid crystal layer. The liquid crystal layer is not shown, because its thickness is negligibly small compared to the thickness of each of the substrates 441 and 442.

Incidentally, a specific construction of each of pixels which constitute the display area of the liquid crystal display panel 4 will be described later in detail.

The liquid crystal display panel 4 has a resolution which is called UXGA, and has pixels each made of three adjacent RGB pixels. The liquid crystal display panel 4 is provided with these pixels in such a manner that 1,600 pixels are horizontally arrayed and 1,200 pixels are vertically arrayed.

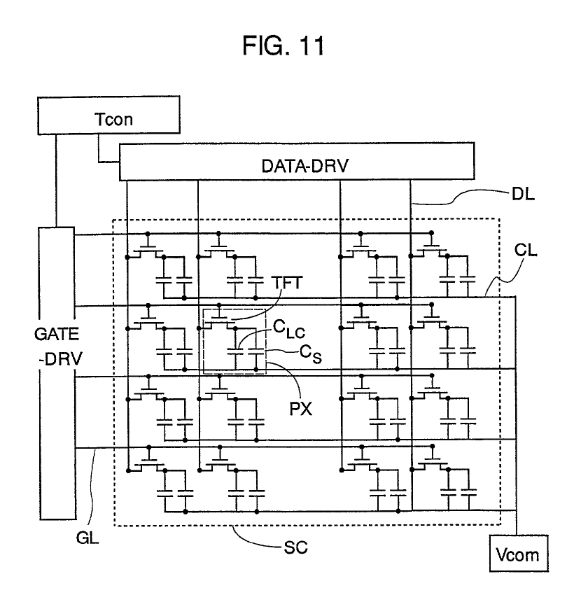

FIG. 11 is a connection diagram showing the outline of the liquid crystal display device, i.e., the equivalent circuit of a display matrix part and peripheral circuits thereof.

Sign Tcon denotes a timing converter circuit, sign SC a picture display area, sign PX a pixel, sign C_{LC} a capacitance of a liquid crystal layer (cell), sign C_{S} an added capacitance of the pixel, sign GATE-DRV a gate signal driver circuit, sign GL a gate signal line, sign DATA-DRV a data signal driver circuit, sign DL a data signal line (video signal line), sign Vcom a counter voltage source, and sign CL a counter voltage signal line.

The liquid crystal display panel 4 illustrated as the present embodiment is a liquid crystal display device which is called an active matrix type, and is known to have the equivalent circuit shown in FIG. 11 by way of example. As shown in FIG. 11, in this kind of liquid crystal display device, the pixels PX (one of which is shown as being surrounded by dashed lines) are arranged two-dimensionally in the picture display area (or screen) SC, and each of the pixels PX has a switching element TFT and at least one pair of electrodes which apply an electric field to the liquid crystal layer (the pair of electrodes forms the capacitance C_{LC} with the liquid crystal layer interposed therebetween). In the liquid crystal display device of the present embodiment, the switching element TFT is denoted by a symbol representative of a field effect transistor, but may also be replaced with a diode or the like.

The corresponding one of the gate line GL is connected to the gate electrode of the symbol representative of the field effect transistor, and a signal is supplied to the gate electrode from the gate signal driver signal GATE-DRV. The gate line GL are disposed as plural parallel lines over the substrate 442, and each of the gate line GL is connected to the switching elements TFT of the respective pixels PX which are arrayed along itself.

An electrical path to be opened or closed by each of the switching elements TFT is connected at one end to one (called a pixel electrode) of the corresponding pair of electrodes which forms the capacitance C_{LC} with the liquid crystal layer interposed therebetween, and is connected at the other end to the corresponding one of the data signal lines DL. The data signal lines DL are disposed, for example, as plural parallel lines over the substrate 442, and each of the data signal lines DL is connected to the other ends of the switching elements TFT of the respective pixels PX which are arrayed along itself. A signal is supplied to the other end of each of the switching elements TFT from the data signal driver circuit DATA-DRV. The one end of each of the switching elements TFT is also called a source electrode and the other end a drain electrode irrespective of their functions for convenience's sake. Accordingly, the data signal driver circuit DATA-DRV is also called a drain signal driver circuit.

The data signal lines DL and the gate line GL are disposed to extend in directions transverse to one another, and over the substrate 442, and are electrically isolated from one another over the substrate 442 by an insulation film (for example, the gate insulating film of each of the field effect transistors).

In the pixel PX shown in FIG. 11, a predetermined voltage is applied from the voltage source Vcom through the corresponding one of the counter voltage signal line CL to the other (called a counter electrode) of the pair of electrodes which forms the capacitance C_{LC} with the liquid crystal layer interposed therebetween. In addition, the added capacitance C_{S} is formed so that the potential difference between the pair of electrodes which forms the capacitance C_{LC} with the liquid crystal layer interposed therebetween is restrained from varying when the switching element TFT is closed. This added capacitance C_{S} is formed, for example, by the pixel electrode and the counter electrode which are opposed to each other with a dielectric layer other than the liquid crystal layer (such as the gate insulating film) interposed therebetween. In a large number of liquid crystal display devices of the kind which is called a TN type (Twisted Nematic type), pixel electrodes and counter electrodes are disposed to oppose one another with liquid crystal layers interposed therebetween, and in a large number of liquid crystal display devices of the kind which is called an IPS type (In-Plane Switching type) or an FFS type (Fringe Field type), pixel electrodes and counter electrodes are disposed over the same substrate. In the case of the TN type, for example, pixel electrodes are separately disposed in the respective pixels PX over the substrate 442, and a counter electrode may also be disposed which has an area to oppose the pixel electrodes of the plural pixels PX arranged over the substrate 441 in the picture display area SC.

In the case of the active matrix type of liquid crystal display device, the switching elements TFT of the plural pixels PX arrayed along the gate line GL are selected and opened for each of the gate line GL, and data signals are supplied to the pixels PX along the individual gate line GL in a time-division manner. A circuit which controls this operation is called the timing converter circuit Tcon. This timing converter circuit Tcon generates, for example, clock signals for the above-described time-division control, and also supplies liquid crystal drive voltages to be applied to the liquid crystal layers which correspond to the individual pixels PX, respectively. A circuit having a function similar to the timing converter circuit Tcon is also utilized in a passive matrix type of liquid crystal display device (represented by an STN (supertwisted nematic) type of liquid crystal display device). Accordingly, the timing converter circuit Tcon is placed as a liquid crystal drive control and power source circuit.

The timing converter circuit Tcon is formed on the timing converter circuit board (printed circuit board) 7 shown in FIGS. 1 to 6, and is disposed on the reverse surface of the third case 3 (the upper surface 33 shown in FIG. 2) as viewed from the user side of the liquid crystal display device. As shown in FIGS. 3A to 3I and 6, in addition to the timing converter LSI 71, the voltage transformation element 72 made of a ferrite core or the like is mounted on the timing converter circuit board 7. Other elements are also formed on the timing converter circuit board 7, but the illustration thereof is omitted for the sake of simplicity in description.

As described above, the timing converter circuit Tcon not only generates signals for picture display control, but also supplies data signal voltages to be applied to the liquid crystal layers. A source voltage of, for example, 12V is supplied to the liquid crystal display device (if an AC voltage of 100V is supplied from an external voltage source, the AC voltage is temporarily converted to a predetermined source voltage value). In contrast, the voltages of the driver ICs which are connected to the gate line GL and the drain line DL are 3V to 5V. On the other hand, voltages to be applied to the liquid crystal layers by the respective pixel electrodes in the individual pixels PX are in the range of, for example, 5V to 10V, although they depend on the kind of liquid crystal compound to be used. In addition, to prevent polarization in each of the liquid crystal layers during the control thereof, it is necessary to invert polarity with respect to the potential of the counter electrode. Accordingly, voltages to be supplied to the respective pixel electrodes are required to be in the range of twice the voltages to be applied to the respective liquid crystal layers; for example, such voltages are required to realize voltage variations of 10V to 20V. For this reason, it is indispensable that the channel-shaped holder 72 be mounted on the timing converter circuit board 7 in order to generate voltage signals of different variation widths for different uses from a predetermined voltage supplied to this timing converter circuit board 7. This requirement is similarly encountered even in the case of a liquid crystal drive control and power source circuit which is incorporated in the passive matrix type of liquid crystal display device.

In the active matrix type of liquid crystal display device, the gate signal driver signal GATE-DRV shown in FIG. 11 includes the plural gate driver ICs 41 shown in FIGS. 1, 3A to 3I and 4. The data signal driver circuit DATA-DRV includes the plural drain driver ICs 42 shown in FIGS. 1, 3A to 3I and 4. The timing converter circuit board 7 and the driver ICs 41 and 42 are connected by the flexible printed circuit board 43. The circuit pattern formed on the flexible printed circuit board 43 is connected at one end to a circuit pattern formed at one end of the printed circuit board 421 on which the data driver ICs 42 are mounted, and the terminal provided at the other end of the flexible printed circuit board 43 is fitted the connector (port) 73 provided on the timing converter circuit board 7, whereby the circuit pattern of the printed circuit board 421 and that of the timing converter circuit board 7 are connected to each other.

Clock signals, drive voltages for the gate driver ICs 41 and the like are supplied from the timing converter circuit board 7 to the gate signal driver signal GATE-DRV through the flexible printed circuit board 43, whereas clock signals, drive voltages for the data driver ICs 42, voltages to be applied to the liquid crystal layers and the like are supplied from the timing converter circuit board 7 to the data signal driver circuit DATA-DRV through the flexible printed circuit board 43. The gate driver ICs 41 which constitute the gate signal driver signal GATE-DRV are mounted on the printed circuit board 411, and the circuit patterns of the printed circuit boards 411 and 421 are interconnected by a joiner (not shown) provided between the printed circuit boards 411 and 421, whereby the gate driver ICs 41 are supplied with voltages and signals from the timing converter circuit board 7. A circuit having a function similar to the above-described construction is also utilized in a passive matrix type of liquid crystal display device and, for example, the gate driver ICs 41 are replaced with counter electrode driver ICs and the data driver ICs 42 with segment driver ICs.

### <<Housing of Liquid Crystal Display Panel 4>>

The liquid crystal display panel 4 is housed between the first case 1 and the second case 2 shown in FIGS. 1 to 3I.

Although not shown in FIG. 1, the picture display area SC shown schematically in FIG. 11 is formed over the upper surface of the liquid crystal display panel 4 shown in FIG. 1. The first case 1 has the aperture 11 in a surface which is in contact with the upper surface, and the user of the liquid crystal display device views the picture display area SC through the aperture 11. The surface having the aperture 11 of the first case 1 is, as shown in FIG. 3A, formed by a plate material made of a metal or the like, which has the upper surface 12 which faces the user side of the liquid crystal display device and the opposite (lower) surface 16. The liquid crystal display panel 4 shown in FIG. 1 is secured to the first case 1 in such a manner that the periphery of its upper surface is in contact with the lower surface 16.

The lower surface (in FIG. 2, the upper surface) of the liquid crystal display panel 4 shown in FIG. 1 is secured to the second case 2 in such a manner that the periphery of the lower surface is in contact with the stepped portion of the upper surface 25 of the second case 2 shown in FIG. 3C. Although not shown in FIG. 3C, an aperture corresponding to the picture display area SC is formed inside the stepped portion of the upper surface 25.

The first case 1 and the second case 2 are secured in the state where the respective peripheries of the upper and lower surfaces of the liquid crystal display panel 4 are maintained in contact with the first case 1 and the second case 2. The periphery of each of the first case 1 and the second case 2 has side walls each formed to extend in a direction transverse to the upper or lower surface of the liquid crystal display panel 4. As shown in FIGS. 1 and 3A, the rectangular notches 14 are formed in the lower side portion of each of the side walls of the first case 1, and the holes 13 are respectively formed at two locations in each of the side walls which are located on the III and IV sides of FIG. 1, respectively. As shown in FIGS. 1 and 3B, the projections 24 are formed on the lower side of each of the side walls of the second case 2 which are respectively located on the III and IV sides of FIG. 1, and the holes 23 are respectively formed at two locations in each of the same side walls.

The liquid crystal display panel 4 is housed between the first case 1 and the second case 2 which are combined with each other in such a manner that the side walls of the second case 2 are respectively covered with the side walls of the first case 1. The holes 13 of the side walls of the first case 1 and the holes 23 of the side walls of the second case 2 are formed so that the holes 13 and the holes 23 are positioned in approximate alignment with one another when the liquid crystal display panel 4 is held between the first and second cases 1 and 2. Threads are formed on the internal walls of at least either the holes 13 or the holes 23. First of all, screws are inserted into the respective holes 23 through the corresponding ones of the four holes 13 formed in the opposite side walls of the first case 1 (at two locations on each of the III and IV sides of FIG. 1), and the first case 1 and the second case 2 are loosely secured to each other.

At this time, the notches 14 of each of the side walls of the first case 1 are located near the corresponding ones of the projections 24 formed on the lower side of each of the side walls of the second case 2 (refer to FIGS. 1, 3C and 5B).

Each of the notches 14 is bent to a position below the corresponding one of the side walls of the second case 2 (i.e., inwardly of the first case 1) so that the upper sides of the rectangular notches 14 (refer to FIGS. 1, 3A and 5A) are brought into abutment with the lower sides of the side walls of the second case 2 that are adjacent to the respective projections 24 (the projections 24 are not formed on the lower sides). Thus, the first case 1 and the second case 2 are secured to each other. In FIG. 6, the side walls of the first case 1 are shown as a contour 1 which is drawn along the outline of the first case 1, and the side walls of the second case 2 are shown as a contour 2 which is adjacent to the contour 1 of the first case 1 (on the top side of FIG. 1, the portion of the second case 2 that is covered with the terrace 15 (to be described later) of the first case 1 is shown by a dashed line). As shown in FIG. 6, the notches 14 of the first case 1 are bent to hold the lower sides of the respective side walls of the second case 2. For example, Japanese Patent Laid-Open No. 199180/1995 has disclosed the art of forming such notches (or claws) in each side wall of one of two cases and forcing the respective notches into recesses formed in the side walls of the other that are in contact with the corresponding side walls of the one case, thereby securing the two cases to each other. Of course, instead of the notches 14, holes may be formed in the side walls of the first case 1, and the side walls of the second case 2 may be extended downwardly and screw holes may be formed in the side walls of the second case 2 at locations corresponding to the respective holes.

As shown in FIGS. 1, 3C and 5B, the upwardly extending projections 26 are formed on the upper side of each of the side walls of the second case 2. Each of the projections 26 is formed by forming a partial cut in the plate member of each of the side walls and folding the partial cut upwardly. Accordingly, openings 261 appear on the upper side of each the side walls at locations corresponding to the projections 26. The projections 26 are formed to serve as guides when the second case 2 is fitted into the space defined by the side walls of the first case 1, and to be in contact with the lower surface 16 of the first case 1 (refer to FIGS. 3A and 5A) when the liquid crystal display panel 4 is housed between the first case 1 and the second case 2. Accordingly, even if a force acts to press both cases 1 and 2 against each other, the force is absorbed by the projections 26 and the lower surface 16 of the first case 1 before it is applied to the liquid crystal display panel 4, thereby preventing damage to the liquid crystal display panel 4, particularly the glass substrates.

As shown in FIGS. 3C and 5B, in addition to the upper surface 25 having the stepped portion for holding the liquid crystal display panel 4, the terraces 22 and 221 are formed on the second case 2 in such a manner that each of the terraces 22 and 221 extends inwardly from the adjacent one of the side walls of the second case 2. The terrace 22 is hidden beneath the upper surface 25 of the second case 2 In FIG. 1, but it is visible in FIG. 2. As shown in FIG. 5B, at the side along which the data driver ICs 42 are disposed, the terrace 24 is formed on the portion where the projections 24 are formed. Gaps are formed between the terraces 22 and 221 and the lower (reverse) surface of the upper surface 25, and the edge portions of the optical sheet 5 shown in FIG. 3D are inserted into the respective gaps to secure the optical sheet 5. The optical sheet 5 is secured in the order of, for example, a prism sheet and a diffusion sheet as viewed from the liquid crystal display panel 4. The prism sheet may also be replaced with a diffusion sheet made of an acrylic sheet printed with dots. In this case, the stepped portion of the upper surface 25 is formed by using a separate member, and the outer periphery of the stepped portion is fitted into the inner periphery of the upper surface 25 which surrounds the stepped portion. In this construction, when the first case 1 and the second case 2 are secured to each other, the diffusion sheet is also reliably secured to the second case 2. The optical sheet may also be replaced with a construction in which a first prism sheet, a first diffusion sheet, a second diffusion sheet and a second prism sheet are secured in that order from the liquid crystal display panel 4, according to the use of the liquid crystal display device or the specifications of a light source unit which will be described later.

### <<Assembling of Optical Unit (Securing of Optical Unit to Third Case 3)>>

As shown in FIGS. 1, 2 and 3F, the third case 3 is made of an upper surface 33 which projects toward the reverse side of the liquid crystal display device as viewed from the user side thereof, side walls 34 which are respectively joined to two opposite sides of the upper surface 33, and terraces 32 which are respectively joined to the upper ends of the side walls 34 and extend in a plane parallel to the upper surface 33. As shown in FIG. 3E, if the user side of the liquid crystal display device is located on the upper side of FIG. 3E, the third case 3 has a cross-sectional shape which is downwardly depressed. In addition, as is apparent from FIGS. 1 and 5C, the downwardly depressed cross-sectional shape appears along the direction in which the gate driver ICs 41 are arrayed, but does not appear along the direction in which the data driver ICs 42 are arrayed.

In this embodiment, the plural cold-cathode tubes 61 which constitute the light source unit of the liquid crystal display device are secured by utilizing the downwardly depressed cross-sectional shape of the third case 3. The cold-cathode tubes 61 are turned on when a higher voltage is supplied to one end of each of the cold-cathode tubes 61 than to the other end thereof. This one end of each of the cold-cathode tubes 61 is called a higher-voltage side (hot side), and the other end a lower-voltage side (cold side). In FIG. 1, the higher-voltage-side end portions of the cold-cathode tubes 61 are respectively fitted in grooves 652 formed in the frame 65, and the rubber bushings 651 are fitted into the respective grooves 652 to secure the cold-cathode tubes 61 to the frame 65. Similarly, the lower-voltage-side end portions of the cold-cathode tubes 61 are respectively fitted in grooves 642 formed in the frame 64, and the rubber bushings 641 are fitted into the respective grooves 642 to secure the cold-cathode tubes 61 to the frame 64. The frames 64 and 65 to which the cold-cathode tubes 61 are secured at their opposite ends are secured to the third case 3 in the state of being in contact with the upper surface 33 and the side walls 34 of the third case 3. FIG. 3E is an assembly diagram of the cold-cathode tubes 61 as viewed from the lower-voltage side. The respective screws 643 are inserted through holes (not shown) formed in the opposite end portions of the frame 64, and the tips of the screws 643 are securely inserted into threaded holes (not shown) formed in the upper surface 33 shown in FIG. 3F (the reverse side of the upper surface 33 as viewed in FIG. 2). The frame 65 to which the higher-voltage sides of the cold-cathode tubes 61 are secured is secured to the third case 3 by similar screws, but the illustration thereof is omitted. The lower-voltage-side terminals of the cold-cathode tubes 61 project from the frame 64, while the higher-voltage-side terminals of the cold-cathode tubes 61 project from the frame 65. The connector 63 is connected to the lower-voltage-side terminals, and the respective connectors 62 to the higher-voltage-side terminals. In the present embodiment, the connector 63 which connects the lower-voltage-side terminals of the plural cold-cathode tubes 61 in parallel is used so that the voltages at the lower-voltage-side terminals are made coincident with the reference voltage of the third case 3 (if the third case 3 itself is held at a ground voltage, the voltages are made coincident with the ground voltage). FIG. 3H is a skeleton view taken in the III direction of FIG. 1, showing the assembled state of the first to third cases 1 to 3, and shows the form in which the lower-voltage-side terminals of the plural cold-cathode tubes 61 are connected to the cable (lead) 631 which passes through the middle portion of the connector 63 shown as a dashed-line box. The connectors 62 each having an individual lead are used for the respective higher-voltage-side terminals of the cold-cathode tubes 61.

As shown in FIG. 1 and in the side view of the assembled state of the first to third case 1 to 3 as viewed in the IV direction, each of four of the connectors 62 assumes the external appearance of being connected to two of the cold-cathode tubes 61. However, the internal wiring of each of the four connectors 62 does not provide electrical conduction between the two connectors 62. This consideration is intended to make uniform the length of the voltage supply passage between each of the higher-voltage-side terminals of the respective cold-cathode tubes 61 and the corresponding one of the voltage transformation elements 81 which supply voltages to the respective higher-voltage-side terminals as will be described later. By connecting the connectors 62 and 63 in the above-described manner, the light source unit is completed of the type in which the plural cold-cathode tubes 61 are disposed in opposition to the liquid crystal display panel 4, i.e., a backlight is mounted directly below a panel. Incidentally, a reflection sheet (not shown) is stuck to the upper surface 33 and the side walls 34 of the third case 3 on the side where the frames 64 and 65 for mounting the cold-cathode tubes 61 are secured to the third case 3. The reflection sheet reflects light radiated to its surface from the cold-cathode tubes 61 toward the liquid crystal display panel 4, thereby enhancing the luminance of the picture display area SC.

The timing converter circuit board 7 shown in FIGS. 1 and 3G and the light source control circuit board (printed circuit board) 8 shown in FIG. 1 are mounted on the upper surface 33 of the third case 3 (on the opposite side to the side where the frames 64 and 65 for mounting the cold-cathode tubes 61 are secured). Each of these circuit boards 7 and 8 is secured with a peripheral portion thereof being brought in engagement with a hanger 333 having an angular shape, the hanger 333 being prepared by forming a cut in a portion of a plate member which constitutes the upper surface 33, raising this cut portion from the upper surface 33 (toward the reverse side of the upper surface 33 as viewed from the user side of the liquid crystal display device), and forming the cut portion into the angle shape. The timing converter circuit board 7 is required to be disposed at a corner of the upper surface 33 so as to take into account the supply of signals and voltages to the gate driver ICs 41 and the data driver ICs 42. For this reason, as shown in FIGS. 2, 3F and 6, portions of one of the side walls 34 of the third case 3 are cut out on the adjacent side of the upper surface 33 and are respectively formed into the aprons 331 whose height coincide with the height of the upper surface 33. The timing converter circuit board 7 is secured by the screws 74 to the threaded holes 334 provided in the respective aprons 331. The light source control circuit board 8 is secured to the upper surface 33 by the screws 82.

The light source control circuit board 8 in the present embodiment is formed of an inverter circuit (a light control circuit) which controls the lighting of the cold-cathode tubes 61, and a power source circuit which supplies voltages to the higher-voltage-side terminals of the cold-cathode tubes 61 in response to the control of the inverter circuit. Since the art of performing stabilization of the lighting of the cold-cathode tubes 61 by using the inverter circuit has already been widely used, the detailed description thereof is omitted. With respect to the drive voltage of not only the inverter circuit but also the light control circuit, the voltages to be supplied to the higher-voltage-side terminals of the cold-cathode tubes 61 are high, for example, 600 V at 6 mA. In contrast, a source voltage to be supplied to the light source control circuit board 8 is low similarly to that of the timing converter circuit board 7. In addition, it is desirable to reduce voltage supply passages through which to supply such high voltages to the higher-voltage-side terminals of the cold-cathode tubes 61. Particularly in the light source unit using the plural cold-cathode tubes 61, the length of the voltage supply passage to each of the cold-cathode tubes 61 is required to be uniform so that the picture display area SC of the liquid crystal display panel 4 can be given uniform brightness. For this reason, the voltage transformation elements 81 for supplying voltages to the higher-voltage-side terminals of the cold-cathode tubes 61 are mounted on the light source control circuit board 8 disposed on the upper surface of the third case 3, and in the case where the plural cold-cathode tubes 61 are juxtaposed as in the present embodiment, the voltage transformation elements 81 are disposed along the array of the cold-cathode tubes 61.

Such requirements for the specifications of the light source control circuit board 8 need to be similarly satisfied not only in the light source unit of the type adopted in the present embodiment in which the backlight is mounted directly below the panel, but also in a construction (light-guide-plate-type light source unit) in which a discharge tube such as the cold-cathode tube 61 is disposed at a location deviated from a position below the picture display area SC of the liquid crystal display panel 4 and a light propagating member called a light guide plate is placed below the picture display area SC so that light emitted from the discharge tube is supplied to the picture display area SC of the liquid crystal display panel 4 through the light guide plate. The reason for this is that even in this construction a high voltage must be supplied to one end of the discharge tube as compared with the above-described other driver circuits.

Accordingly, the circuit pattern of the light source control circuit board 8 and the shape of each of the higher-voltage-terminal-side connectors 62 connected to the light source control circuit board 8 are designed to take those requirements into account.

In contrast to the wiring on the higher-voltage side of the cold-cathode tubes 61 where their voltage supply passages are restricted in length, the form of wiring on the lower-voltage side of the cold-cathode tubes 61 has a degree of freedom in design. For example, as shown in FIG. 6, the cable 631 may also be extended from the lower-voltage-side terminals of the cold-cathode tubes 61 to the light source control circuit board 8 across the upper surface 33 of the third case 3.

As shown in FIG. 6, on the upper surface 33 of the third case 3, there is a vacant place where neither the timing converter circuit board 7 nor the light source control circuit board 8 is disposed. This vacant place is suited to an area in which optional circuits are to be mounted by a manufacturer that incorporates the liquid crystal display device into a set product such as a personal computer, a liquid crystal display monitor or a television set. The opening 335 formed in the center of the upper surface 33 is provided as a measuring window for a photosensitive element which measures the luminance of the cold-cathode tubes 61. In a case where a luminance monitoring circuit for the light source unit is mounted on the vacant place of the upper surface 33 of the third case 3, the luminance of emission from the light source unit is measured through the opening 335, and the measured result is fed back to the control circuit mounted on the light source control circuit board 8, whereby the brightness of the liquid crystal panel 4 can be kept stable.

### <<Assembling of Liquid Crystal Display Device (Securing of Third Case 3 to Second Case 2)>>

As described above, the third case 3 in which the light source unit is incorporated and the timing converter circuit board 7 and the light source control circuit board 8 are secured is secured to the second case 2. The construction in which the third case 3 is secured to the second case 2 is shown in FIG. 3H as a skeleton view taken in the III direction of FIG. 1, in FIG. 4 as a skeleton view taken in the IV direction of FIG. 1, and in FIG. 5D as a skeleton view taken in the V direction of FIG. 1.

As shown in the left-side portion of FIG. 3H, the terrace 32 formed at one end of the third case 3 and the terrace 22 which projects inwardly from the inside of one of the side walls of the second case 2 are secured to each other by screws 322. The terraces 32 and 22 are secured at three locations as shown in FIG. 5D. The length of each of the screws 322 is designed so that the screws 322 are prevented from extending through the terrace 22 and projecting from the upper surface thereof to an excessive extent.

In the right-side portion of FIG. 3H, a recess is formed by the terrace 221 which projects from the inside of the opposite one of the side walls of the second case 2 and the terrace 15 which projects from the inside of one of the side walls of the first case 1. The terrace 32 formed at the other end of the third case 3 is fitted into the recess. In the process of securing the third case 3 to the second case 2, first, the terrace 32 at the other end of the third case 3 is fitted into the recess, and then the terrace 32 at one end of the third case 3 are superposed on the terrace 22 and are secured to the same with the screws 322.

In the right-side portion of FIG. 3H, the above-described recess using the terrace 15 may not be formed, and threaded holes may be formed in the terrace 221 of the second case 2 so that the terrace 32 at the other end of the third case 3 is secured to the terrace 221 by screws. This construction makes simple the design of the first case 1.

In the case where the terraces 32 are screwed to the terraces 22 and 221, the following care must be taken: if the optical sheet has a slightly enlarged size, the tips of the screws which project from the upper surfaces of the terraces 22 and 221 will press end portions of the optical sheet. As the result of this pressure, there is a possibility that unexpected polarization components are given to light which is made incident on the liquid crystal display panel 4 from the light source unit. To avoid this possibility, it is preferable to adopt a construction in which the terrace 32 at the other end of the third case 3 are fitted into the recess. In addition, in the present embodiment, the position at which the terrace 32 at one end of the third case 3 is screwed to the terrace 22 of the second case 2 is set to a position near the inside surface of one of the side walls of the second case 2 away from the picture display area SC of the liquid crystal display panel 4. Furthermore, this screwing position is disposed on the side where the data driver ICs 42 are disposed. The reason for these is that a position which satisfies at least one of these conditions lies in a dead space with respect to the arrangement of the optical sheet even if the design error of the position is taken into account (there is no possibility that the optical sheet is extended to such position). In addition, in the present embodiment, as shown in FIGS. 5A and 5B, the projections 24 are formed on the lower side of each of the side walls of the second case 2, and the notches 14 formed in the lower side portion of each of the side walls of the first case 1 are fitted into the right and left sides of the corresponding projections 24. For this reason, it is impossible to screw the terrace 32 to the terrace 22 at the fitting positions of the notches 14 in the vicinity of the side walls of the second case 2. Accordingly, the terrace 22 which has the projections 24 formed at its end as shown in the lower side of FIG. 6 is used for screwing, because the notches 14 are not fitted to the lower surface of this terrace 22. In addition, the whole of the terrace 32 of the third case 3 is not extended to the inside surface of the side wall of the second case 2, and as shown in FIGS. 2 and 6, portions to be used for screwing are extended as the aprons 321 to the inside surface of the side wall of the second case 2 and the end portions of the respective portions are used for screwing.

The securing of the respective terraces 32 of the third case 3 to the terraces 22 and 221 of the second case 2 may be achieved by a method other than the above-described screwing of the terraces 32 or the fitting of the terraces 32 into the recesses. For example, clips (not shown) may be provided on the terrace 22 of the second case 2 so that the aprons 321 projecting from the terraces 32 are clamped between the clips. The clips may be provided by securing elastic clip members to the terrace 22 by screwing, soldering or welding. In the case where the second case 2 is formed of an elastic metal or resin, cuts may be partially formed in the second case 2 so that the cut portions are raised from the surface of the second case 2 which is in contact with the aprons 321. In this case, the restoring forces of the cut portions of the terrace 22 are utilized to secure the aprons 321.

When the third case 3 is secured to the second case 2, the liquid crystal display device of the present embodiment is completed. FIG. 3I is a side view showing the external appearance of the liquid crystal display device MDL as viewed in the III direction of FIG. 1. As compared with the skeleton view of FIG. 3H, the external appearance shown in FIG. 3I is very simple. This liquid crystal display device is also called a liquid crystal display device, and actually is sold to a consumer in the form of being incorporated in a personal computer, a liquid crystal display monitor or a television set.

### <<Setting of Projections 31 on Upper Surface of Third Case 3>>

Although not conspicuous in the external appearance shown in FIG. 3I, in many actual cases, the upper end of the voltage transformation element 72 mounted on the timing converter circuit board 7 projects from the lower sides of the side walls of the first case 1. As viewed in the IV direction of FIG. 1, i.e., from the side on which the light source control circuit board 8 is mounted, the upper ends of the voltage transformation elements 81 mounted on the light source control circuit board 8 project from the side walls of the first case 1 as shown in the skeleton view of FIG. 4.

If the elements secured to this assembled case project from the case of the liquid crystal display device, there is a possibility that the elements are damaged when the liquid crystal display device is incorporated into a so-called set product such as a personal computer, a liquid crystal display monitor or a television set. A similar possibility occurs during the transport of liquid crystal display devices to a manufacture of such set products.

In the present invention, the projections 31 are disposed on the upper surface 33 of the third case 3 (the reverse surface as viewed from the user side of the liquid crystal display device) so that elements (such as electronic components) secured to the case which constitutes the liquid crystal display device can be protected against the above-described damage. The reason why the projections 31 are disposed on the upper surface 33 is as follows.

As described previously, the light source unit is disposed in the third case 3. In addition, as described previously, the first case 1 and the second case 2 hold therebetween the peripheries of the upper and lower surfaces of the liquid crystal display panel 4, and the liquid crystal display panel 4 is housed between the first case 1 and the second case 2. One of the upper and lower surfaces of the liquid crystal display panel 4 needs to allow light from the light source unit to enter the liquid crystal layer provided in the liquid crystal display panel 4, while the other needs to enable a picture generated by the modulation of the light in the liquid crystal layer to display to the user of the liquid crystal display device. To this end, in each of the first case 1 and the second case 2, an aperture (for example, the aperture 11 of the first case 1 shown in FIG. 3A) is formed to face an adjacent one of the surfaces of the liquid crystal display panel 4 (the main surface of one of the pair of substrates 441 and 442 included in the liquid crystal display panel 4). However, it is not necessary to form an aperture in a member which holds the light source unit of the third case 3 (the upper side of the upper surface 33 shown in FIG. 3F). For this reason, it is desirable to mount on this member the timing converter circuit board 7 and the light source control circuit board 8, because these boards 7 and 8 can be stably secured to the liquid crystal display device. Accordingly, since the electrical circuit elements to be protected by the projections 31 are secured to the timing converter circuit board 7 and the light source control circuit board 8, the electrical circuit elements are automatically disposed on the upper surface 33 of the third case 3.

Each of the first case 1 and the second case 2 has an enlarged area which faces the adjacent one of the surfaces of the liquid crystal display panel 4, in order to protect the periphery of the liquid crystal display panel 4 inclusive of the driver ICs. Contrarily, the light source unit needs only to supply light to the picture display area SC of the liquid crystal display panel 4, and the area of the light source unit that faces the adjacent one of the surfaces of the liquid crystal display panel 4 needs only to be approximately equivalent to the picture display area SC or to be slightly extended beyond the periphery of the picture display area SC (the area of the light source unit need not be extended to the driver-IC sides of the liquid crystal display panel 4). As is apparent from this fact, each of the first case 1 and the second case 2 is formed to be larger in size than the third case 3 as viewed in a direction perpendicular to the surfaces of the liquid crystal display panel 4 (for example, from the viewpoint of FIG. 6). In other words, the upper surface 33, the side walls 34 and the terraces 32 all of which constitute the third case 3 are housed within the external frame of each of the first case 1 and the second case 2.

Accordingly, for the protection of the electrical circuit elements disposed on the upper surface 33 of the third case 3, it is more advantageous to provide the projections 31 or equivalent on the third case 3 than on the first case 1 or the second case 2.

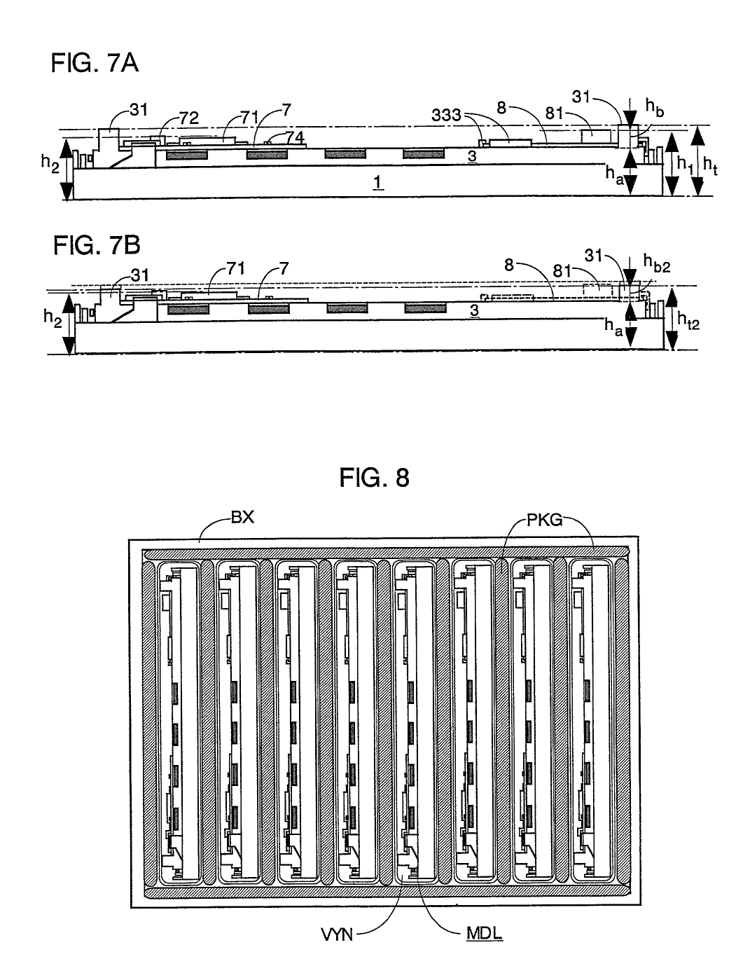

FIGS. 7A and 7B are explanatory views of a first construction according to the present invention. FIG. 7A shows the liquid crystal display device of FIG. 5A in an upside-down state. In the following description, the dimension of the liquid crystal display device taken in the vertical direction of FIGS. 7A and 7B is referred to as “thickness” or “height”, while the dimension of the liquid crystal display device taken in the horizontal direction of FIGS. 7A and 7B is referred to as “width” or “area”.

It can be seen from FIG. 7A that assuming that the projections 31 are absent on the upper surface 33 of the third case 3, a thickness hi of the liquid crystal display device is determined by the voltage transformation elements 81 mounted on the light source control circuit board 8. If neither the timing converter circuit board 7 nor the light source control circuit board 8 is disposed on the upper surface of the third case 3, the thickness of the liquid crystal display device is determined by a difference ha in height between the upper surface 12 of the first case 1 (refer to FIG. 3A) and the upper surface 33 of the third case 3 (refer to FIG. 3F) (the hanger 333 is ignored). For this reason, the projections 31 are disposed on the upper surface 33 of the third case 3, and the height hb of each of the projections 31 is determined to satisfy the relationship of hb>h1−ha.

Consequently, although the thickness (maximum thickness) of the entire liquid crystal display device increases to ht (where ht>h1), the positions where the projections 31 are formed are set back from the periphery of the liquid crystal display device, whereby the projections 31 do not adversely affect the process of mounting the liquid crystal display device on a set product.

Some manufacturers of set products may incorporate a light source driver circuit into the body of a set product such as a personal computer and employ a liquid crystal display device without mounting the light source control circuit board 8 thereon. In this case, as can be seen from FIG. 7A with the light source control circuit board 8 and all the elements mounted thereon being hypothetically erased from FIG. 7A, a thickness h2 of the liquid crystal display device exclusive of the projections 31 is determined by the voltage transformation element 72 mounted on the timing converter circuit board 7. As is apparent from FIG. 7A, the projections 31 of height hb are higher than necessary in terms of the protection of the electrical circuit elements mounted on the timing converter circuit board 7; rather, there may occur a possibility that the projections 31 hinder the process of incorporating the liquid crystal display device into a set product.

In this case, a member different that shown in FIG. 7A may be prepared as the third case 3. The third case 3 shown in FIG. 7A includes the projections 31 each formed to have a height hb2 (where hb2>h2−ha). Owing to this construction, the thickness (maximum thickness) of the entire liquid crystal display device on which the light source control circuit board 8 is not mounted becomes ht2 which is smaller than the height h1.

As is apparent from the above description, even if the liquid crystal display panels 4 of the same dimensions are respectively mounted on liquid crystal display devices, there is a possibility that the dimensions of the cases of each of the liquid crystal display devices change to a considerable extent according to whether the light source control circuit is mounted on the liquid crystal display device. In the present invention, the third cases 3 which differ in the height of the projections 31 are prepared to cope with variations of the liquid crystal display device. However, in the case where projections or convex portions are formed on the side walls of the first case 1 or the second case 2 to realize the protection of the electrical circuit elements, the following problems will occur.

One problem is that lines to be used for manufacturing two kinds of liquid crystal display device products which merely differ from each other regarding the presence or absence of a light source control circuit must be separately provided for the sake of mounting the liquid crystal display panel 4. Since both the first case 1 and the second case 2 are members which hold the liquid crystal display panel 4, if either one is changed in shape, complicated procedures are required to assembly liquid crystal display device products through the same line, resulting in a lowering of productive efficiency.

The other problem is that if a delay or a defective product occurs during the assembling of the first case 1 and the second case 2 for either one of the two kinds of liquid crystal display device products, the production of products of that kind will be delayed.

However, in the present invention, since the shape of the third case 3 is changed to cope with the production of the two kinds of liquid crystal display device products, the step of holding the liquid crystal display panel 4 between the first case 1 and the second case 2 as well as the resultant intermediate products can be applied in common to these two kinds of products.

Moreover, the present invention has the following advantage regarding the transport of liquid crystal display device products.

This advantage will be described below with reference to the explanatory view of FIG. 8 which shows the state in which liquid crystal display devices (also called liquid crystal display modules) are packaged for shipping.

In FIG. 8, sign BX denotes a transporting corrugated carton (for example, a shipping box), sign PKG packing (shock absorbing) members, sign VYN vinyl bags, and sign MDL liquid crystal display modules (the above-described liquid crystal display device products). The liquid crystal display modules MDL shown in FIG. 8 adopts the present invention in which the projections 31 for protecting circuit elements are disposed on the third case 3 (In FIG. 8, plural liquid crystal display modules which are of a type similar to that shown in FIG. 7A are shown on a reduced scale and in the state of being rotated by 90 degrees.)

Cushion members such as urethane foams are used as the packing members PKG within the inner walls of the transporting corrugated carton BX. The respective liquid crystal display modules MDL are put in the vinyl bags VYN, and are housed in the transporting corrugated carton BX. The packing members PKG are also inserted between the liquid crystal display modules MDL, and in many cases, corrugated cardboards are used for such packing members PKG.

In this form of packaging, the projections 31 formed on each of (the third cases 3) of the liquid crystal display modules MDL suppress the warp of the packing member PKG inserted between such projections 31 and those formed on an adjacent one of the liquid crystal display modules MDL, thereby preventing warped ones of the packing members PKG from pressing and damaging the electric circuit elements mounted on the liquid crystal display modules MDL.

As described previously, the area of the third case 3 that faces the main surface of the substrates 441 and 442 (which are also called a liquid crystal display substrate) included in the liquid crystal display panel 4 is smaller than that of each of the first case 1 and the second case 2. For this reason, the disposition of the projections 31 on the third case 3 offers the advantage that the positions of the projections 31 can be set near the electrical circuit elements to be protected. Assuming that the projections 31 are disposed on the first case 1 or the second case 2, the positions of the projections 31 are distant from the electrical circuit elements. The packing members PKG are warped between the positions of the projections 31 and the positions of the electrical circuit elements by that distance. From this point of view, it is apparent that damage to the electrical circuit elements can be reliably prevented by disposing the projections 31 on the third case 3.

Incidentally, the voltage transformation elements 72 and 81 mounted on the timing converter circuit board 7 and the light source control circuit board 8 are made of members such as ferrite cores. Although the height of such a voltage transformation element depends on its transformation function, the voltage transformation element is in many cases the highest of all the elements mounted on the timing converter circuit board 7 and the light source control circuit board 8. It is also said that such voltage transformation elements do not have a high resistance to mechanical shock, as compared with semiconductor ICs (integrated circuit devices) molded with resins (resin materials). As stated previously, it is preferable to set the projections 31 to be higher than the upper end of the voltage transformation element 72 which determines the thickness of the liquid crystal display device exclusive of the projections 31 (i.e., the tallest element on the upper surface 33 of the third case 3). However, if attention is directed to only damage to the elements during transport, the projections 31 may also be set higher than the upper end of the highest one of the voltage transformation elements mounted on the upper surface 33 of the third case 3 (even if the projections 31 are lower than, for example, the other semiconductor ICs). The criterion of this setting of the height of the projections 31 may be changed according to the specifications of each kind of liquid crystal display device (the variations of electrical circuit elements to be mounted).

In the above description, the projections 31 are formed on the upper surface 33 of the third case 3. Instead, cuts may be partly formed in each of the side walls 34 and the cut portions may be bent so that one end of each of the cut portions reaches a position higher than the upper surface 33 (in the layout shown in FIGS. 7A and 7B). Otherwise, such cuts may also be formed in the terraces 32 (the positions of the cuts may be arbitrarily changed according to the layout of the timing converter circuit board 7 or the light source control circuit board 8).

### <<Maintenance of Light Source Unit>>

As described previously in the section “Assembling of Liquid Crystal Display Device (Securing of Third Case 3 to Second Case 2)”, the present invention provides a second construction in which the securing of the third case 3 and the second case 2 is effected separately from the securing of the first case 1 and the second case 2. This construction serves the advantage of easing the burden of the maintenance of the light source unit in the liquid crystal display device (liquid crystal display module).

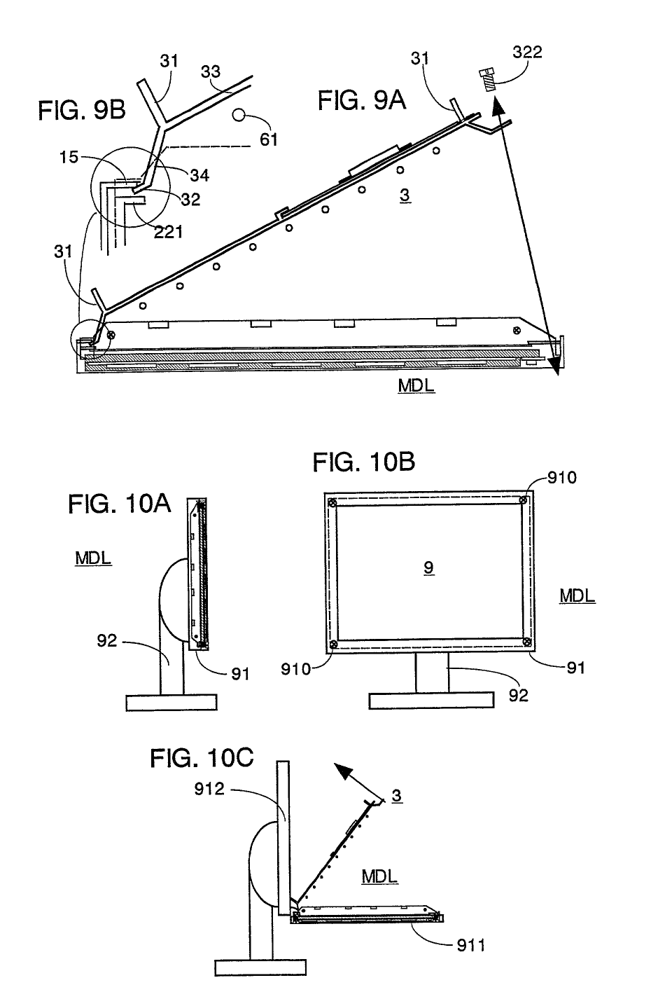

FIGS. 9A and 9B are explanatory views of the second construction according to the present invention. FIG. 9A is a view showing the state in which the light source unit (the third case 3 on which the light source unit is mounted) is removed from the liquid crystal display device, and FIG. 9B is an enlarged view of the structure shown within a circle in FIG. 9A. The structure shown in FIG. 9A is equivalent to the upside-down one of the structure shown in FIGS. 3H and 3I.

As described previously, the terrace 32 formed at the other end of the third case 3 (along the periphery where the data driver ICs 42 are not disposed) is fitted into the recess formed between the terrace 15 of the first case 1 and the terrace 221 of the second case 2. If the screws 322 are removed which secure to the terrace 22 of the second case 2 the terrace 32 formed at one end of the third case 3 (along the periphery where the data driver ICs 42 are disposed), the one end of the third case 3 is raised as shown in FIG. 9A. The terrace 32 at the other end of the third case 3 is allowed to move in the recess according to the raise of the one end of the third case 3, because the distance from the side wall 34 to the end of the terrace 32 formed at the other end of the third case 3 is shorter than the distance from the side wall 34 to the end of the terrace 32 formed at the one end. When the third case 3 is raised to some extent, the third case 3 can be removed from the second case 2 (the liquid crystal display module MDL).

The third case 3 removed from the liquid crystal display module MDL is placed with the upper surface 33 (the surface on which the timing converter circuit board 7 and others are mounted) being faced down (toward a working bench), and maintenance of the light source unit and replacement of components are performed; for example, a cold-cathode tube 61 which has degraded in lighting performance is replaced. The shown third case 3 has the projections 31 according to the first structure of the present invention described previously, but if such projections 31 are not formed, a jig for holding the opposite terraces 32 of the third case 3 may be prepared so that the components of the timing converter circuit board 7 or the light source control circuit board 8 are prevented from coming into abutment with a working bench or a desk.

As is apparent from FIG. 9, in the case of components, such as the liquid crystal display panel 4 and the optical sheet 5, which are excluded from the range of maintenance of the light source unit, it is possible to perform the maintenance work with such components remaining secured to the liquid crystal display module MDL. Assuming that the first case 1 and the second case 2 are separated during the maintenance of the light source unit, an enormous period of time is required to detach and attach the liquid crystal display panel 4 and the optical sheet 5, particularly, to align the liquid crystal display panel 4 and the optical sheet 5 after the completion of the maintenance. Although the influence of the optical sheet 5 depends on the specifications thereof, the quality of display pictures is greatly influenced by the optical sheet 5 according to whether the optical sheet 5 is aligned with the liquid crystal display panel 4 as well as owing to dust or the like which penetrates into the gap between the liquid crystal display panel 4 and the optical sheet 5 during aligning work.

The second structure of the present invention eases the burden of maintenance and inspection to be imposed on a user or a maintenance engineer of a set product such as a personal computer, a liquid crystal display monitor or a television set, even if the liquid crystal display module MDL remains mounted in the set product.

FIGS. 10A, 10B and 10C show one example of a monitor using a liquid crystal display device which embodies the second structure according to the present invention. FIG. 10A is a side view, FIG. 10B is a front view (a view seen from the monitor side, i.e., the user side of the monitor), and FIG. 10C is a side view showing the state in which a light source unit is removed from the monitor.

A liquid crystal display monitor 9 is made of a picture display part 91 and a liquid crystal display part support base 92, and the picture display part 91 is made of a picture display part front box 911 and a picture display part rear box 912. Although not shown, the liquid crystal display part support base 92 is provided with a power source unit for converting a power (for example, 100 V) supplied from the outside into a voltage (for example, 12 V) common to the interior of the liquid crystal display monitor 9, and an interface circuit for receiving a signal from an external computer.

The liquid crystal display module MDL is secured in the interior of the picture display part front box 911 by screws 910 (in FIG. 10B, the contour of the liquid crystal display module MDL is shown by dashed lines). The screws 910 are inserted through either or both of the first case 1 and the second case 2 of the liquid crystal display module MDL, and secures either or both of the first and second cases 1 and 2 to the inner walls of the picture display part front box 911. The screws 910 may employ screws each having a length which does not reach the third case 3 of the liquid crystal display module MDL, or the third case 3 may be partially depressed in portions which the respective screws 910 are liable to reach. This contrivance is intended to prevent the screws 910 from disabling the third case 3 from being removed from the second case 2.

As shown in FIG. 10C, after the picture display part front box 911 is opened from the picture display part rear box 912 secured to the liquid crystal display part support base 92 and the back of the liquid crystal display module MDL (the upper-surface side of the third case 3 is exposed, the maintenance of the light source unit of the liquid crystal display module MDL of this liquid crystal display monitor 9 can be performed in a way identical to that described above with reference to FIGS. 9A and 9B.

### <<Structure of Pixel>>

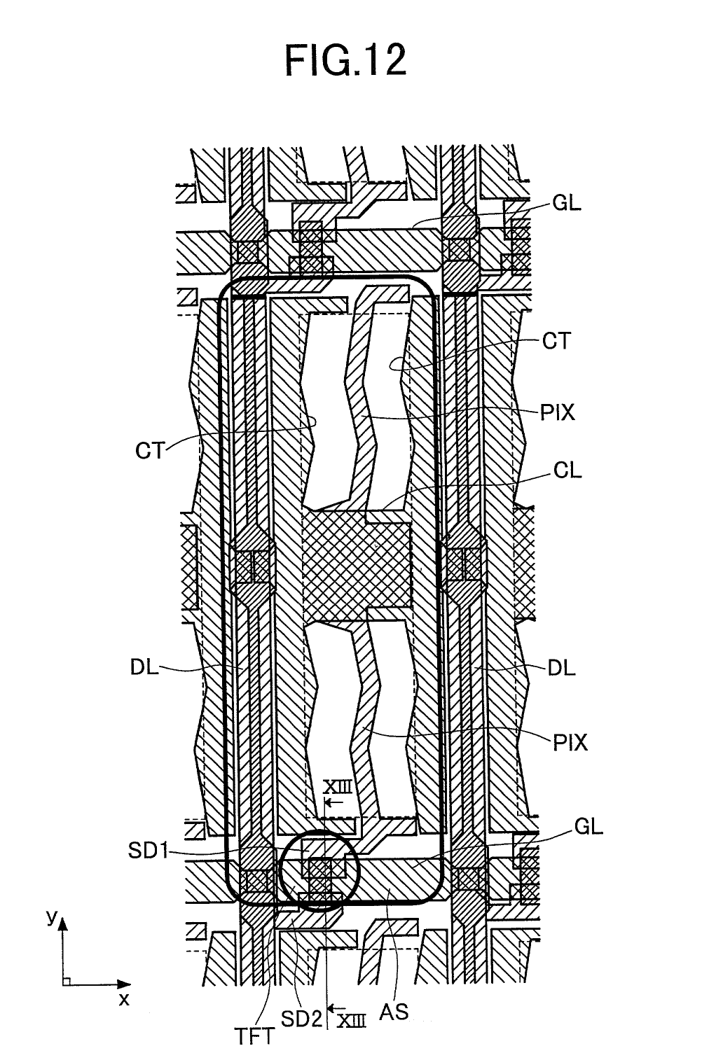

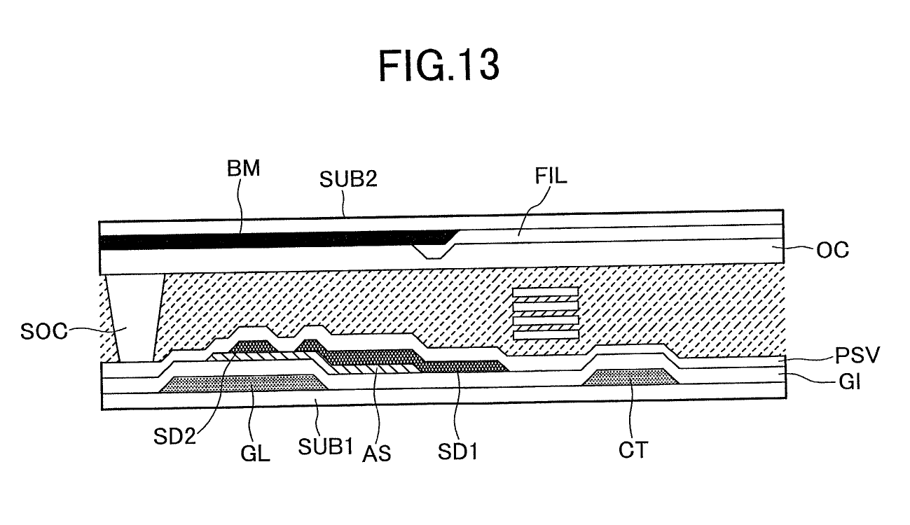

FIG. 12 is a plan view showing one embodiment of the pixel structure of the liquid crystal display panel 4, and shows a liquid-crystal-side surface of one of a pair of transparent substrates disposed to oppose each other with a liquid crystal. FIG. 13 shows a cross-sectional view taken along line XIII-XIII of FIG. 12 as well as the other transparent substrate.

Referring first to FIG. 12, gate line GL are formed to be extended over a surface of a transparent substrate SUB 1 in the x-direction of FIG. 12 and to be juxtaposed in the y-direction of FIG. 12. Each of the gate line GL is made of, for example, a stacked layer in which chromium and an alloy of chromium and molybdenum are stacked in that order. This stacked layer is formed to has a thickness of about 200 nm.

The width of each of the gate line GL is set within the range of 7-15 μm, and the resistance per one of the gate line GL each of which is formed to extend over individual pixels juxtaposed in the x-direction of FIG. 12 is 60 kΩ or less.

Areas are partitioned in such a manner that each of the areas are surrounded by adjacent ones of the gate line GL and adjacent ones of drain line DL which will be described later (the drain line DL are disposed to be extended in the y-direction and to be juxtaposed in the x-direction). Each of the areas constitutes the area of a unit pixel.

A counter signal line CL is formed to be extended through the middle of each of the pixel areas in the x-direction, and the counter signal lines CL are formed at the same time as the gate line GL (therefore, the counter signal lines CL are made of the same material as the gate line GL).

Each of the counter signal lines CL is formed to extend through the pixels which is disposed to be juxtaposed in the x-direction of FIG. 12, and the resistance per one of the counter signal lines CL is set to 15 kΩ or less.

The counter signal line CL has a counter electrode CT formed integrally with the same, and the counter electrode CT will be described later in connection with a pixel electrode PIX to be described later.

An insulating film GI (refer to FIG. 13) which is made of, for example, SiN and has a thickness of about 350 nm is formed over the surface of the transparent substrate over which the gate line GL and the counter signal lines CL (the counter electrodes CT) are formed in the above-described manner. The insulating film GI is formed to cover each of these signal lines GL and CL (electrodes).

This insulating film GI has the function of an interlayer insulating film between the gate line GL and the counter signal lines CL with respect to the drain line DL which will be described later, the function of a gate insulating film in an area in which a thin film transistor TFT which will be described later is formed, and the function of a dielectric film in an area in which a capacitance element Cstg which will be described later is formed. The thin film transistor TFT is formed to be superposed on part of the gate signal line GL in a bottom left portion of the pixel area shown in FIG. 12 (in the portion surrounded by a thick circle in FIG. 12).

Specifically, an about-200-nm-thick semiconductor layer AS made of, for example, amorphous Si is formed on that portion, and a drain electrode SD2 and a source electrode SD1 (which means an electrode to be connected to the pixel electrode PIX which will be described later) are formed on the upper surface of the semiconductor layer AS, thereby forming a MIS transistor having a so-called inverted-staggered structure which uses part of the gate signal line GL as its gate electrode.

The source electrode SD2 of the thin film transistor TFT is formed integrally with the drain line DL, and the source electrode SD1 is formed at the same time as the drain line DL.

Specifically, the drain line DL which are formed to be extended in the y-direction of FIG. 12 and to be juxtaposed in the x-direction of FIG. 12 are formed of a stacked layer in which chromium and an alloy of chromium and molybdenum are stacked in that order. Part of each of the drain line DL is formed to be extended to the surface of the semiconductor layer AS to constitute the drain electrode SD2. The stacked layer is formed to have a thickness of about 180 nm.

Each of the drain line DL has a width which is set within the range of about 8-15 μm, and is formed to extend over individual pixels juxtaposed in the y-direction of FIG. 12 and the resistance per one of the drain line DL is set to 25 kΩ or less.

In this case, the source electrode SD1 of the thin film transistor TFT is formed at the same time, and the pixel electrode PIX is also formed integrally with the a first case 1.

The pixel electrode PIX is formed to be extended through the middle of the pixel area in the y-direction of FIG. 12, and a voltage of about 6.5 V is applied across the pixel electrode PIX and each of the counter electrodes CT which are formed on the opposite sides of the pixel electrode PIX, thereby generating an electric field.

The respective counter electrodes CT are formed adjacent to the drain line DL, whereby each of the counter electrodes CT absorbs a video signal (noise) supplied through the adjacent one of the drain line DL but not selected by the thin film transistor TFT, thereby preventing the video signal from affecting the pixel electrode PIX.

The pixel electrode PIX has a zigzag-shaped strip-like pattern which has, for example, three bends in each of the upper and lower areas separated by the counter signal line CL as viewed in FIG. 12, and the side of each of the counter electrodes CT that is adjacent to the pixel electrode PIX has a zigzag-shaped uneven pattern so that the distance from each of the counter electrodes CT to the counter electrode CT is kept constant (the shortest distance: in this embodiment, 0.018 nm); that is to say, a so-called multi domain scheme is adopted. Accordingly, since portions in each of which an electric field has a different direction are formed between the pixel electrode PIX and the counter electrode CT, a variation in color tone does not appear even when a display screen is viewed in any of directions which differ in viewing angle.

The pixel electrode PIX is formed so that the area of the pixel electrode PIX that is superposed on the counter signal line CL is enlarged in its portion transverse to the counter signal line CL, and a storage element C_{S} is formed in this portion. The capacitance of the storage element Cs is set to about 200 fF or less, preferably 180 fF.

The storage element Cs is provided for purposes such as storing pixel information supplied to the pixel electrode PIX, for a comparatively long period when the thin film transistor TFT is turned off.

A protective film PSV of thickness about 50 nm is formed to cover the surface on which the drain line DL and the pixel electrodes PIX are formed in this manner.

A transparent substrate SUB2 formed in this manner is disposed to oppose the transparent substrate SUB1 with the liquid crystal LC interposed therebetween, and the black matrix BM is formed over the liquid-crystal-side surface of the transparent substrate SUB2 to define the peripheries of the individual pixel areas, and a color filter FIL is formed in each opening of the black matrix BM.

An overcoat film OC made of, for example, a resin is formed on the surfaces of the black matrix BM and the color filters FIL which are formed in this manner, so as to form a surface free of steps.

Columns SOC made of, for example, a resin material are dispersedly formed over the overcoat film OC so as to hold the gap (equivalent to the thickness of the liquid crystal layer) between the overcoat film OC and the opposite transparent substrate SUB1.

Incidentally, in this embodiment, the space between each adjacent one of the drain line DL is set to 0.080 mm, and the space between each adjacent one of the gate line GL is set to 0.240 mm, and each of the openings of the black matrix BM is made approximately coincident in central axis with the corresponding one of the pixel area surrounded by the adjacent drain line DL and the adjacent gate line GL, and the horizontal and vertical lengths of each of the openings are slightly smaller than 0.080 mm and 0.240 mm, respectively.

### <<Consideration of Delay Time of Signal>>

This section considers the delay time of a signal in each signal line in the liquid crystal display device constructed in the above-described manner.

As described above, the liquid crystal display panel 4 used in the present embodiment has a resolution of UXGA and has signal lines which are longer than those of other liquid crystal display panels of resolution XGA and SXGA (the result panel size necessarily becomes larger), so that so-called luminance irregularity easily occurs due to the distortion of signal waveforms.

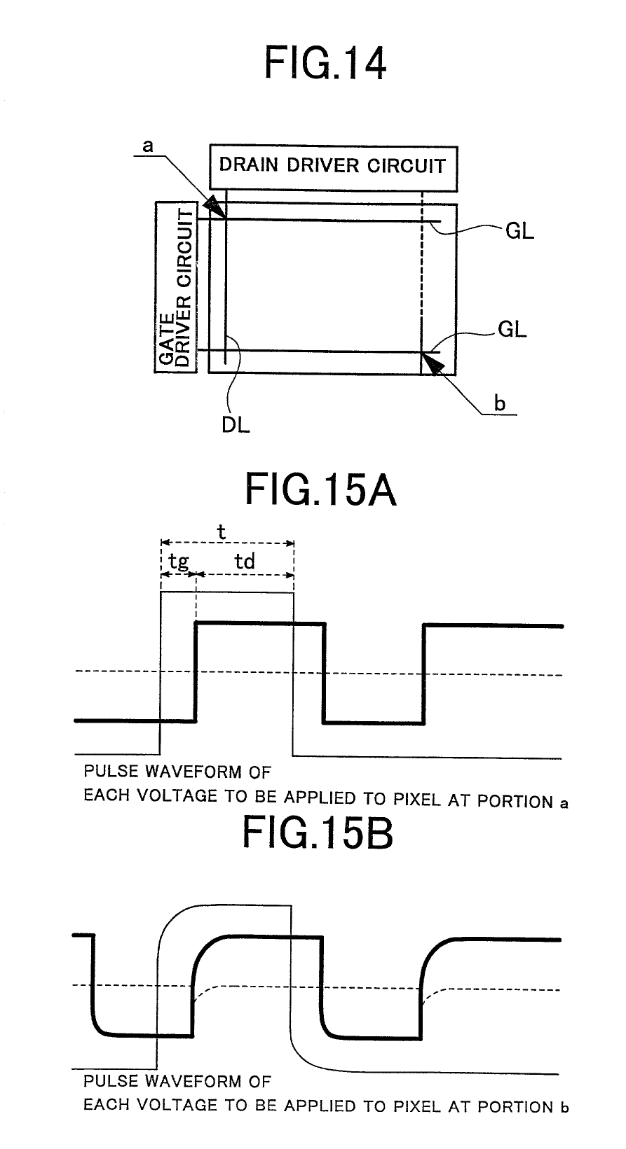

First of all, a description will be given of the case in which, as shown in FIG. 14, a scanning signal is supplied from only one side of each of the gate line GL and a video signal is supplied from only one side of each of the drain line DL.

FIG. 15A shows the voltage waveforms of a scanning signal, a video signal and a counter voltage all of which are supplied to a pixel (a portion a of FIG. 14) which is located on the side where the gate line GL are connected to a gate driver circuit and on the side where the drain line DL are connected to a drain driver circuit,

In FIG. 15A, the voltage waveform of the scanning signal is shown by a thin solid line, the voltage waveform of the video signal by a thick solid line, and the voltage waveform of the counter voltage by a dotted line.

If the voltage of the scanning signal changes from low to high, the thin film transistor TFT in the pixel is turned on and the voltage of the video signal is supplied to the source electrode of the thin film transistor TFT.

After a charge corresponding to the voltage of the video signal has been stored in the storage capacitance element Cs connected to the source electrode, if the voltage of the scanning signal changes from high to low, the thin film transistor TFT is turned off and the charge is held in the storage capacitance element Cs, whereby the optical transmissivity of the liquid crystal is controlled by an electric field generated by the difference voltage between the counter electrode and the pixel electrode due to the charge.

FIG. 15B is a view corresponding to FIG. 15A, and shows the voltage waveforms of a scanning signal, a video signal and a counter voltage all of which are supplied to a pixel (a portion b of FIG. 14) which is located on a side fully away from the gate driver circuit and on a side fully away from the drain driver circuit.

As is apparent from FIGS. 15A and 15B, distortions occur in the respective voltage waveforms according to the lengths of the corresponding signal lines. Such distortions are introduced by causes such as the resistances of the respective signal lines, the capacitances at the intersections of the gate line and the thin film transistors TFT and the capacitances at the intersection of the gate line and the drain line.

For this reason, even if a video signal of the same voltage level as the pixel in the portion a is supplied to the pixel in the portion b, a predetermined video signal voltage cannot be fully applied to the storage capacitance element Cstg of the pixel in the portion b, so that differences occur among the optical transmissivities of light of the respective pixels, causing luminance irregularity.

In the case of a normal liquid crystal display device, it is necessary to refresh sixty pictures per second, and in the case of UXGA, a picture write time tH to be assigned to one line (the time for which the voltage of a scanning signal is high) is 1÷60÷1200=13.8 μs. Actually, the picture write time tH is shorter, and if the time of pixel driving with data is taken into account, the picture write time tH becomes 13.5 μs. From this fact, it is necessary to converge each waveform within 13.5 μs.

The picture write time tH is divided into two major elements, one of which is a period tg during which the voltage of a scanning signal is made to change from low to high, and the other of which is a period ts during which the voltage of a video signal and the voltage of a counter voltage are made to reach predetermined levels, respectively.

The timing of changing the voltage of the video signal deviates by tg from the timing of changing the voltage of the scanning signal at their rises and falls.

This is because in the case where the voltage of the scanning signal is higher than that of the video signal while the voltage of the scanning signal is changing from high to low, the thin film transistor TFT is on and if the voltage of the video signal changes during this time, the amount of stored charge changes accordingly.

In addition, ts=(tH−tg) is the period during which charge is supplied to the capacitance storage element Cstg, and during the period ts, the voltage of the video signal and the counter voltage at least need to reach the respective predetermined levels.

To satisfy these requirements, in the present embodiment, during the period tg=0.15 tH, the voltage of the scanning signal is converged by 70% or more with respect to the amount of variation in the voltage of the same, and during the period ts=0.85 tH, the voltage of the video signal is converged by 99.8% with respect to the amount of variation in the voltage of the same and the counter voltage is converged by 99% or more with respect to the amount of variation in the common voltage.

The 70% convergence of the voltage of the scanning signal is a value which reaches about 14.5 V when the low voltage and high voltage of the scanning signal are −35 V and 22 V, respectively. In the case of driving with a video signal having a voltage of 0.2 to 14.8 V, such 70% convergence is a value which approximately exceeds the voltage level of the video signal and can turn on the thin film transistor TFT.

The 99.9% convergence of the voltage of the video signal, during driving with a drain voltage of 0.2 to 14.8 V, the voltage of the video voltage can be applied to the portion b as a voltage of 25 mV or less which makes a luminance difference invisible. In addition, in the case of the 99% convergence of the common voltage, during dot inversion driving, the counter voltage can be applied to the portion b as a voltage of 25 mV or less which makes a luminance difference invisible.

If a delay time τ per one line (the product of the total resistance and the total capacitance) is calculated from the convergence of each of the signal voltages on the basis of a distributed constant circuit, the delay time τ is 3.8 μs or less in the case of the scanning signal line, 4.0 μs or less in the case of the video signal line, and 5.7 μs or less in the case of the counter signal line.

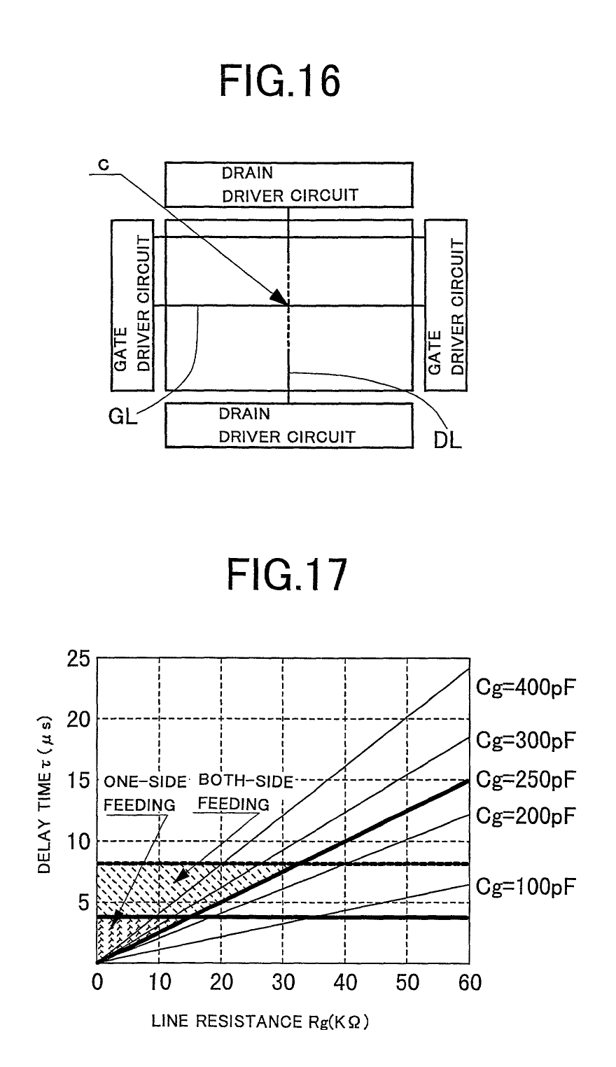

The above description has referred to the case where a scanning signal is inputted from one side of each gate signal line and a video signal is inputted from one side of each drain line, but there is a case where, as shown in FIG. 16, a scanning signal is inputted from both sides of each gate signal line and a video signal is inputted from both sides of each drain line.

In this case, the center of the gate line (in FIG. 16, a portion c) is a location where convergence is difficult, but the convergence time is reduced to about ½ compared to the above-described case. Accordingly, in this case, the delay time τ per one line is 7.6 μs or less in the case of the scanning signal line, 8.0 μs or less in the case of the video signal line, and 11.4 μs or less in the case of the counter signal line.

FIG. 17 is a graph in which the relationship between the resistance and the delay time τ of a gate signal line is plotted against variations in its gate capacitance. It has been confirmed that in this case and in the gate signal line, there exists a minimum intersection capacitance value due to the formation of a drain line and a thin film transistor TFT, and the minimum value is about 250 pF. From this fact, it can be seen that resistances and capacitances usable in the present invention are in the range of a hatched area of FIG. 17.

Incidentally, in FIG. 17, the term “one-side feeding” indicates the case where a signal is inputted from one side of a signal line, and the term “both-side feeding” indicates the case where a signal is inputted from both sides of a signal line.

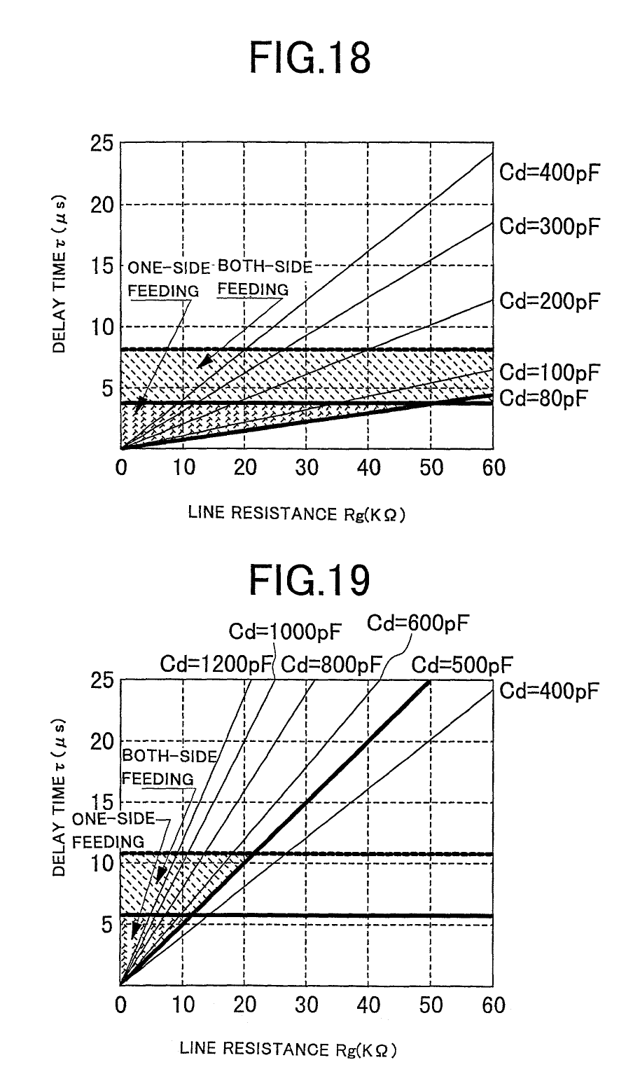

FIG. 18 is a graph in which the relationship between the resistance and the delay time τ of a drain line is plotted against variations in its drain capacitance. In this case, it has been proved that in the drain line, there exists a minimum intersection capacitance value due to a gate signal line, and the minimum value is about 80 pF. From this fact, it can be seen that resistances and capacitances usable in the present invention are in the range of a hatched area of FIG. 18.

Incidentally, in FIG. 18 as well, the term “one-side feeding” indicates the case where a signal is inputted from one side of a signal line, and the term “both-side feeding” indicates the case where a signal is inputted from both sides of a signal line.

FIG. 19 is a graph in which the relationship between the resistance and the delay time r of a counter signal line is plotted against variations in its counter capacitance. In this case, it has been proved that in the counter signal line, there exists a minimum intersection capacitance value due to a gate signal line, and the minimum value is about 500 pF. From this fact, it can be seen that resistances and capacitances usable in the present invention are in the range of a hatched area of FIG. 19.

Incidentally, in FIG. 19 as well, the term “one-side feeding” indicates the case where a signal is inputted from one side of a signal line, and the term “both-side feeding” indicates the case where a signal is inputted from both sides of a signal line.

As can be seen from these graphs, it is preferable that the range of resistances to be adopted for each of the signal lines be made comparatively high. This is because if the widths of the signal lines are increased to decrease their resistances, an improvement in aperture ratio is not realized and the efficiency of utilization of light decreases.

From this fact, if the one-side feeding is applied to drain line and the both-side feeding is applied to gate line and counter signal lines, it is appropriate that the resistance and the capacitance of each of the signal lines are respectively made as follows: in the case of the gate line, 30 kΩ or less and 290 pF or more; in the case of the drain line, 15 kΩ or less and 250 pF or more; in the case of the counter signal lines, 29 kΩ or less and 600 pF or more.

In the present embodiment, in the case of each of the gate line, the resistance and the capacitance are made 30 kΩ and 290 pF; in the case of each of the drain line, 30 kΩ and 110 pF; and in the case of each of the counter signal lines, 16 kΩ and 1000 pF.

### <<Consideration of Relationship between Space between Pixel Electrode and Counter Electrode and Dielectric Anisotropy of Liquid Crystal>>

In the driving of a liquid crystal, when a potential difference is provided between two electrodes, an electric field E is generated, and the orientation of liquid crystal molecules changes from their initial alignment state owing to the field strength of this electric field E. The amount of change due to the electric field E differs according to the values of the physical properties of individual liquid crystal materials. Specifically, regarding a liquid crystal threshold voltage at which such change starts, a liquid crystal threshold voltage Vth based on the theory of continuum theory is in general expressed as the following Eqn. (1):

Vₜₕ=πI/d{square root over ((K2/ε0|Δε|)}, Eqn. (1)

where d represents a cell gap, K2 represents the elastic constant of a twist, Δε represents the dielectric anisotropy of a liquid crystal, and I represents the distance between electrodes.

As is apparent from this expression, if a change in the orientation of the liquid crystal is to be made remarkable with respect to the constant electric field E, it is desirable to decrease the liquid crystal threshold voltage Vth.

From this fact, since I and d respectively have influences on the transmissivity of pixels and the color deviation of transmitted light and K2 is difficult to change arbitrarily, Δε is changed to change the threshold voltage Vth.

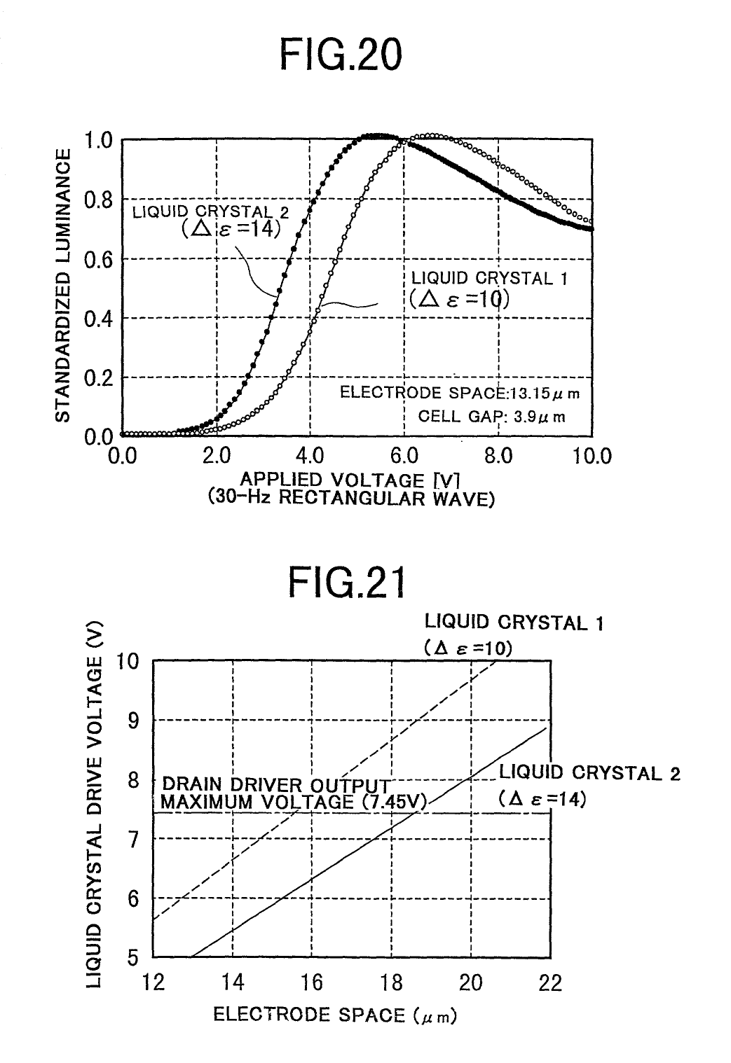

FIG. 20 is a graph showing the voltage-transmissivity relationship measured with liquid crystal materials of different Δε under the same conditions. In the graph, Δε1 of a liquid crystal 1 is 10.3, Δε2 of a liquid crystal 2 is 14.

The relationship between voltages Vsat1 and Vsat2 for the maximum transmissivities of the respective liquid crystals 1 and 2 obtained from Eqn. (1) is expressed as the following Eqn. (2), and coincides with the measured result:

Vₛₐₜ₂≈{square root over (Δε1/Δε2)×Vsat1)}. Eqn. (2)

If the relationship between each of Vsat1 and Vsat2 and the electrode space is found from this result, the graph shown in FIG. 21 is obtained.

From this graph, it is apparent that if the electrode space is 18 μm, Δε needs to be 14 or more (Δε=14) to drive the liquid crystal.

Incidentally, this electrode space of 18 μm is necessary in the case where a drive voltage to be applied between the electrodes is set to a predetermined value, but it has been confirmed that the electrode space may also be 18 μm or less if the drive voltage is in the range of 7.0-8.6 V. Accordingly, this construction has the advantage of reducing pixel size.

### <<Consideration of External Size>>

If the liquid crystal display monitor shown in FIGS. 10A, 10B and 10C is used on a general desk, the depth of the desk is about 700 mm and the viewing distance (the space between the display device and an operator) is in the range of about 700-900 mm.

In the case of an operator having a visual acuity of 1.0, the operator can resolve a visual angle of one minute and the range of resolvable sizes of one pixel is calculated as about 0.200 to 0.254 mm, and it can be assumed that this range of pixel sizes has no problem in terms of resolution.

Accordingly, if a liquid crystal display device is constructed to have such a pixel size and a resolution of UXGA, it is optimal to set each diagonal of its display area which is an area of assembly of pixels to the range of about 15.7″ to 20″.

If the display area is increased in this manner, there occurs a possibility that at least two to five operators observe one monitor at the same time. For this reason, it is desirable that any of the operators can recognize a picture free of color deviation even while they are gazing at any of four corners of the display area. Therefore, the display area is required to be free of color deviation when it is viewed at least an angle of 70° or more from above, below, right or left.

Accordingly, a liquid crystal display device of the type which can satisfy such requirement is a liquid crystal display device which has a pixel construction based on a so-called in-plane switching mode. A far more optimum liquid crystal display device is of a type which operates in an in-plane switching mode such as that shown in FIG. 12 and adopts a so-called multi domain scheme.

In addition, a liquid crystal display device having a higher resolution and a larger screen size requires a larger power consumption, and an AC/DC power source and a control circuit for controlling contrast and luminance are incorporated in the device, so that its internal temperature increases.

If the total power consumption reaches, for example, 80 W or more, the liquid crystal display device needs to be forcedly cooled with a fan or the like, but the rotation noise of the fan will give an operator or the like an uncomfortable feeling. Accordingly, it is preferable to reduce the total power consumption to 80 W or less without the need for forced cooling, and the present embodiment is constructed in that manner. Incidentally, from a similar viewpoint, not in the case of a liquid crystal display monitor (a device in which an AC/DC power source and a circuit for controlling contrast and luminance are mounted) but in the case of a liquid crystal display module incorporated in a decorative case (a device in which an AC/DC power source and a circuit for controlling contrast and luminance are not mounted), it is preferable that the power consumption be suppressed to 52 W or less.

The power consumption is classified into two kinds, power consumption consumed by a peripheral circuit part for forming pulse voltages for driving the liquid crystal of a liquid crystal display panel, and power consumption consumed by a backlight for supplying light to the side of an operator via a liquid crystal display panel.

The power consumption of the peripheral circuit part varies according to drive frequency, liquid crystal drive voltage and liquid crystal panel load.

In a liquid crystal display monitor having a resolution of UXGA as in the present embodiment, the drive frequency is approximately 165 MHz.

Regarding the liquid crystal drive voltage, liquid-crystal driving driver ICs having dynamic ranges of 15 V or less are used (since the polarity of application of an electric field is periodically inverted during the driving of the liquid crystal, 15/2 7.5 V is the maximum value of an actual liquid crystal drive voltage).

The liquid crystal panel load is dominated by the intersection capacitances of each of lines arranged in matrix form within the liquid crystal display panel and the parasitic capacitances of thin film transistors TFT in individual pixels, and the value of the liquid crystal panel load is 7-10 W.

For this reason, it is necessary to suppress the power consumption of the backlight to 42-45 W or less. In this case, if cold-cathode tubes are to be used as a light source, the usable number of cold-cathode tubes is approximately 10. If recognition of visual display is to be enabled even at an angle of 70° from above, below, right or left, the liquid crystal display panel needs a luminance equivalent to ⅓ of its axial luminance, and the axial luminance is a maximum of 9000-10000 cd/m².

The result is that the display device needs 200 cd/M² or more and the transmissivity of the liquid crystal display panel needs at least 2.0%.

If the display area has a diagonal of 15.7″ to 20″, its lateral display size is 320-406 mm. To enable efficient use of a desk space, it is desirable to accommodate the lateral display size within the size of information terminal equipment. A device which is usually disposed on a desk as information terminal equipment other than the liquid crystal display monitor is at least a keyboard.

The lateral external sizes of keyboards are 450-470 mm with ten-key pads (370-400 mm without ten-key pads), and it is desirable that the entire liquid crystal display monitor be constructed within the above-described range.

If the monitor cases and the holding mechanisms of liquid crystal display devices are taken into consideration, it is appropriate to make the lateral external sizes of keyboards far smaller to 410-430 mm (350-380 mm).

In this case, the display diagonal sizes of the liquid crystal display devices can be set to the range of 17.6-20 inches, and the density of pixels can be made 100 dpi or more.

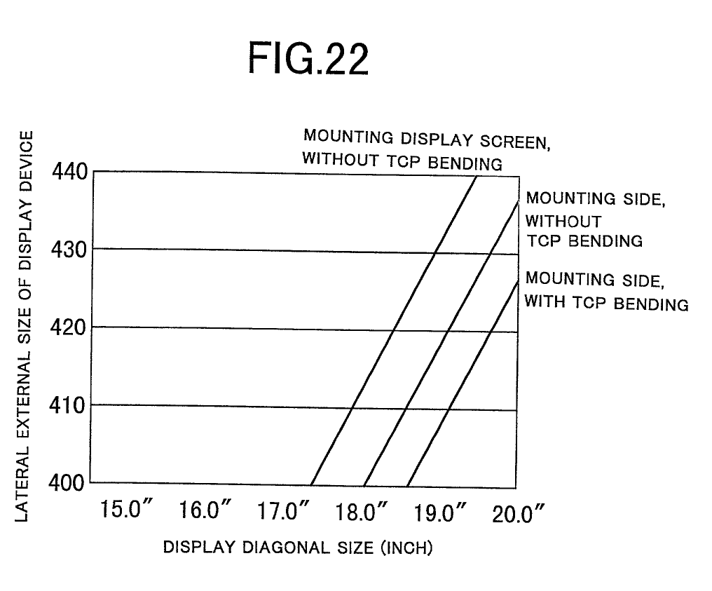

FIG. 22 shows the relationship between the diagonal display size of a liquid crystal display device and the lateral size of the liquid crystal display device. Although display diagonal sizes more or less differ according to mounting methods and the structures of TCPs, as is apparent from FIG. 22, display diagonal sizes of 18″ to 20″ are appropriate. In addition, display diagonal sizes of 18.6″ to 19.1″ are far more desirable to satisfy the above-described external shape irrespective of the kind of mounting method.

Conventionally, the display diagonal sizes of liquid crystal display devices of 17.6-20 inches are calculated on the basis of a pixel density of 100 dpi. Specifically, the pixel density is just 100 dpi for 20 inches and 113 dpi for 17.6 inches, and in the case of smaller display diagonal sizes, the pixel pitch cannot be accommodated within 0.2-0.54.

Although the present invention has been specifically described above on the basis of the embodiments, the present invention is not limited to any of the above-described embodiments, and it goes without saying that various modifications can be made without departing from the gist of the present invention.

As is apparent from the foregoing description, according to the present invention, it is possible to obtain a liquid crystal display device free of luminance irregularity.

In addition, since the area of each pixel can be made small, it is possible to form the entire liquid crystal display device into an appropriate size.

What is claimed is:

1. A liquid crystal display device comprising:
a pair of substrates;
a plurality of gate lines for receiving a scanning signal;
a plurality of drain lines for receiving a video signal;
a liquid crystal layer interposed between said pair of substrates;
a thin film transistor formed on one of said pair of substrates and coupled to one of said gate lines and to one of said drain lines, said thin film transistor being driven by said scanning signal from said gate line;
a pixel electrode formed on one of said pair of substrates and configured to be supplied with said video signal from said thin film transistor;
a counter electrode formed on one of said pair of substrates for receiving a counter voltage signal from a counter voltage signal line;
a plurality of pixels defined by a matrix arrangement of said gate lines and said drain lines on one of said pair of substrates; and
a UXGA display area comprising said pixels.
each gate line characterized in that said scanning signal has a delay time of 3.8 μs or less across said gate line.

2. The liquid crystal display device according to claim 1 wherein said drain line is characterized in that said video signal has a delay time of 4.0 μs or less across said drain line.

3. The liquid crystal display device according to claim 1 wherein said counter voltage signal line is characterized in that said counter voltage signal has a delay time of 5.7 μs or less across said counter voltage signal line.

4. The liquid crystal display device according to claim 1 wherein said scanning signal has a picture write time of 13.8 μs or less.

5. The liquid crystal display device according to claim 1 wherein said gate lines and said counter voltage signal line are disposed in one of said pair of substrates, said gate lines and said counter voltage signal line extending in an x-direction and are juxtaposed along a y-direction, and said drain line disposed in one of said pair of substrates and extending in the y-direction.

6. The liquid crystal display device according to claim 5 wherein a resistance of each said gate line is 60 kΩ or less, a resistance of said counter voltage signal line is 15 kΩ or less, and a resistance of said drain line is 25 kΩ or less.

7. The liquid crystal display device according to claim 6 wherein said pixel electrode and said counter electrode are formed in different layers.

8. The liquid crystal display device according to claim 7 further including a first insulating film and a second insulating film, wherein said gate line is disposed in the same layer as said counter electrode, said drain line is disposed with said first insulating film and interposed between said drain line and said gate line, and said pixel electrode is disposed with said second insulating film and interposed between said pixel electrode and drain line.

9. The liquid crystal display device according to claim 8 wherein said second insulating film is an organic layer.

10. A liquid crystal display device comprising:
a pair of substrates;
a liquid crystal layer interposed between said pair of substrates;
a plurality of gate lines disposed in one of said pair of substrates and extending in an x-direction, said gate lines having a juxtaposed relation along a y-direction;
a plurality of drain lines disposed in one of said pair of substrates and extending in the y-direction;
a plurality of counter voltage signal lines disposed in one of said pair of substrates and extending in an x-direction, said counter voltage signal lines having a juxtaposed relation along a y-direction;
a plurality of pixels being defined by an arrangement of said gate lines and said drain lines in a matrix configuration; and
a UXGA display area being constituted by said pixels, said gate lines configured so that an applied scanning signal has a delay time of 7.6 μs or less at a central area of said UXGA display area.

11. The liquid crystal display device according to claim 10 wherein drain lines are configured so that an applied video signal has a delay time 8.0 μs or less at a central area of said UXGA display area.

12. The liquid crystal display device according to claim 10 wherein said counter voltage signal lines are configured so that an applied counter voltage signal has a delay time of 11.4 μs or less at a central area of said UXGA display area.

13. The liquid crystal display device according to claim 10 wherein said gate lines are configured to receive a scanning signal from both sides of said gate lines.

14. The liquid crystal display device according to claim 11 wherein said drain lines are configured to receive a video signal from both sides of said drain lines.

15. The liquid crystal display device according to claim 12 wherein said counter voltage signal lines are configured to receive a counter voltage signal from both sides of said counter voltage signal lines.

16. A liquid crystal display device comprising:
a pair of substrates;
a liquid crystal layer interposed between said pair of substrates;
an plurality of pixels arranged in a matrix of 1600 columns x 1200 rows, pixels in each row arranged in groups of three, each group of three comprising an R pixel, a B pixel, and a G pixel;
a pixel electrode and a counter electrode formed in each of said pixels;
a driving voltage to be applied between said pixel electrode and said counter electrode in the range of 7.0 V-8.6 V; and
a separation between said pixel electrode and said counter electrode of 18 μm or less, said liquid crystal having a dielectric anisotropy of 14 or more.

17. The liquid crystal display device according to claim 16 further including a decorative case having a lateral length ranging from 410 to 430 mm, a display diagonal size ranging from 17.6 to 20 inches, and said pixels being 100 dpi or more in density.

18. The liquid crystal display device according to claim 17 further including a keyboard device whose length is smaller than said lateral length of said decorative case

19. The liquid crystal display device according to claim 17 wherein said gate lines each has a line length of 320 mm to 406.4 mm within said pixel area, and said drain lines each has a line length of 240 mm to 304.8 mm within said pixel area.

20. The liquid crystal display device according to claim 19 wherein each of said gate lines performs sixty refreshes for one second.
